(19) United States
(12) Patent Application Publication
(10) Pub. No.: US 2002/0103793 A1
(43) Pub. Date: Aug. 1, 2002

(54) Method and apparatus for learning probabilistic relational models having attribute and link uncertainty and for performing selectivity estimation using probabilistic relational models

(76) Inventors: Daphne Koller, Belmont, CA (US); Lise Getoor, Mountain View, CA (US); Avi Pfeffer, Cambridge, MA (US); Nir Friedman, Mevasert Zion (IL); Ben Taskar, Stanford, CA (US)

Correspondence Address: GLENN PATENT GROUP, 3475 EDISON WAY, SUITE L, MENLO PARK, CA, 94025, US

(21) Appl. No.: 09/922,324

(22) Filed: Aug. 2, 2001

Related U.S. Application Data
(60) Provisional application No. 60/222,700, filed on Aug. 2, 2000.

(51) Int. Cl. G06F 7/00

(52) U.S. Cl. 707/3; 707/104.1

(57) ABSTRACT

The invention comprises a method and apparatus for learning probabilistic models (PRM's) with attribute uncertainty. A PRM with attribute uncertainty defines a probability distribution over instantiations of a database. A learned PRM is useful for discovering interesting patterns and dependencies in the data. Unlike many existing techniques, the process is data-driven rather than hypothesis driven. This makes the technique particularly well-suited for exploratory data analysis. In addition, the invention comprises a method and apparatus for handling link uncertainty in PRM's. Link uncertainty is uncertainty over which entities are related in our domain. The invention comprises of two mechanisms for modeling link uncertainty: reference uncertainty and existence uncertainty. The invention includes learning algorithms for each form of link uncertainty. The third component of the invention is a technique for performing database selectivity estimation using probabilistic relational models. The invention provides a unified framework for the estimation of query result size for a broad class of queries involving both select and join operations. A single learned model can be used to efficiently estimate query result sizes for a wide collection of potential queries across multiple tables.

This invention was made with Government support under contract N66001-97-C-8554, awarded by the Space and Naval Warfare Systems Center and N00014-97-C-8554, awarded by the Office of Naval Research. The Government has certain rights in this invention.

### BACKGROUND OF THE INVENTION

1. Technical Field

The invention relates to statistical models of relational databases. More particularly, the invention relates to a method and apparatus for learning probabilistic relational models with both attribute uncertainty and link uncertainty and for performing selectivity estimation using probabilistic relational models.

2. Description of the Prior Art

Relational models are the most common representation of structured data. Enterprise business information, marketing and sales data, medical records, and scientific datasets are all stored in relational databases. Efforts to extract knowledge from partially structured, e.g. XML, or even raw text data also aim to extract relational information.

Recently, there has been growing interest in extracting interesting statistical patterns from these huge amounts of data. These patterns give us a deeper understanding of our domain and the relationships in it. A model can also be used for reaching conclusions about important attributes whose values may be unobserved. Probabilistic graphical models, and particularly Bayesian networks, have been shown to be a useful way of representing statistical patterns in real world domains.

Recent work (see for example G. F. Cooper, E. Herskovits, A Bayesian method for the induction of probabilistic networks from data, Machine Learning, 9:309-347 (1992) and D. Heckerman, A tutorial on learning with Bayesian networks, M. I. Jordan, editor, Learning in Graphical Models, MIT Press, Cambridge, Mass. (1998)) develops techniques for learning these models directly from data, and shows that interesting patterns often emerge in this learning process.

However, all of these learning techniques apply only to flat file representations of the data, and not to the richer relational data encountered in many applications.

Probabilistic relational models (PRM) are a recent development (see for example D. Koller, A. Pfeffer, Probabilistic framebased systems, Proc. AAAI (1998); D. Poole, Probabilistic Horn abduction and Bayesian networks, Artificial Intelligence, 64:81-129 (1993); and L. Ngo, P. Haddawy, Answering queries from context sensitive probabilistic knowledge bases, Theoretical Computer Science, (1996)) that extend the standard attribute based Bayesian network representation to incorporate a much richer relational structure. These models allow the specification of a probability model for classes of objects rather than simple attributes. They also allow properties of an entity to depend probabilistically on properties of other related entities. The model represents a generic dependence, which is then instantiated for specific circumstances, i.e. for particular sets of entities and relations between them.

However, this previous work assumes that the probability models are elicited and defined by domain experts. This process is often time-consuming and error-prone. However, there may be existing relational databases that contain information about the domain. It would be beneficial if there were a method for making use of this existing information.

It would be advantageous to provide a mechanism and apparatus that automatically constructs a probabilistic relational model from a database. In addition, it would be beneficial to incorporate link uncertainty into the basic PRM framework and provide a mechanism for automatically constructing these models as well. Finally, it would be advantageous to provide a technique that can automatically construct and make use of a PRM for database query optimization.

### SUMMARY OF THE INVENTION

The invention provides a method and apparatus for automatically constructing a PRM with attribute uncertainty from an existing database. This method provides a completely new way of uncovering statistical dependencies in relational databases. This method is data-driven rather that hypothesis driven and therefore less prone to the introduction of bias by the user.

The invention also provides a method and apparatus for modeling link uncertainty. The method extends the notion of link uncertainty first introduced by Koller and Pfeffer (see D. Koller, A. Pfeffer, Probabilistic framebased systems, Proc. AAAI (1998)). The invention provides a substantial extension of reference uncertainty, which makes it suitable for a learning framework. The invention also provides a new type of link uncertainty, referred to herein as existence uncertainty. A framework for automatically constructing these models from a relational database is also presented.

The invention also provides a technique for constructing a probabilistic relational model of an existing database and using it to perform selectivity estimation for a broad range of queries over the database.

Thus, the invention provides:

1. A method for learning probabilistic models from a relational database, and using it for:

a. Reaching conclusions about attributes unobserved in the data

b. Inferring significant statistical patterns present in the data

c. Visualizing the significant dependencies in the data in a graphical form.

d. Approximating the result size of a relational query.

e. Supporting decisions based on these conclusions, such as:

i. Ordering the operations in a complex query, for the purpose of query optimization.

ii. Making decisions about actions relating to individual objects in the database, including medical decisions about patients, marketing decisions about customers, etc.

iii. Classification of objects into multiple different types, based on their attributes and the attributes of the objects to which they are related.

2. Methods for learning probabilistic models of attributes of multiple objects in a relational database (a Probabilistic Relational Model), including any of:

a. Dependencies between attributes of a single object

b. Dependencies between attributes of related objects, whether linked directly or indirectly via a chain of relations.

c. Statistical dependency model for each attribute, as a stochastic function of the other attributes on which is depends.

3. A method as in (2), wherein different possible models are scored using a scoring function that makes use of the entire relational database.

4. The method as in (2), wherein a heuristic search algorithm is used to find a high-scoring function in the space of possible models.

5. Methods for determining the coherence of a PRM, whether learned or constructed by other means, e.g., via elicitation from experts, for guaranteeing that the PRM specifies a consistent probability distribution for any database to which it can be applied. This includes both methods for arbitrary databases, as well as methods for databases that are guaranteed to satisfy prior constraints.

6. Methods for learning a PRM with a probabilistic model over the link structure between objects in the domain. This includes both a model of the presence of a link between two objects, as well as models for the endpoints of such a link.

7. The method as in (6), wherein different possible models are scored using a scoring function that makes use of the entire relational database.

8. The method as in (6), wherein a heuristic search algorithm is used to find a high-scoring function in the space of possible models.

9. Methods for using a PRM with a probabilistic model over link structure for inferring properties of objects (values of attributes of objects) based on the link structure in the model as well as on known properties of objects in the database.

10. The use of a probabilistic graphical model, whether a Bayesian network or a PRM, for evaluating the query result size of a query in a relational database, for the purpose of query optimization, approximate query answering, and other uses.

11. A method as in (10), wherein the same PRM is used to estimate the size of a query over any subset of attributes in said database, and wherein prior information about a query workload is not required.

12. A method as in (11), wherein selectivity estimation is performed for select queries over a single table, and wherein a Bayesian network is used to approximate the joint distribution over an entire set of attributes in said table.

13. A method as in (11), wherein selectivity estimation is performed for queries over multiple tables, and wherein a PRM is used to accomplish both select and join selectivity in a single framework.

14. A method as in (13), wherein selectivity estimation is performed via the construction of a query evaluation Bayesian network from the PRM, for the said query.

15. A method as in (2), wherein the database is such that some of the attribute values are missing, or the database contains hidden attributes, whose values are never observed in the data, or both.

16. A method as in (6), wherein the database is such that some of the attribute values are missing, or the database contains hidden attributes, whose values are never observed in the data, or both.

### BRIEF DESCRIPTION OF THE DRAWINGS

FIG. 1 is a block diagram showing an instantiation of the relational schema for a simple movie domain;

FIG. 2 is a block schematic diagram showing the PRM structure for the TB domain;

FIG. 3 is a block schematic diagram showing the PRM structure for the Company domain;

FIG. 4 is a block schematic diagram showing the PRM learned using existence uncertainty;

FIG. 5 is a block diagram showing a high-level description of the selectivity estimation process;

FIGS. 6a-6c comprise a series of tables which show joint probability distribution for a simple example (FIG. 6a), a representation of the joint probability distribution that exploits the conditional independence that holds in the distribution (FIG. 6b), and representation of the single-attribute probability histograms for this example (FIG. 6c);

FIGS. 7a and 7c comprise tree diagrams that show a Bayesian network for the census domain (FIG. 7a) and a tree-structured CPD for the Children node (children in household), specifying the conditional probability of each of its values (N/A, Yes, No), given each possible combination of values of its parent nodes Income, Age, and Marital-Status (FIG. 7b), where the presentation of the tree is simplified by merging consecutive split on the same attribute into a single split;

FIGS. 8 and 8b comprise tree diagrams that show a PRM for the Tuberculosis domain (FIG. 8a) and a query-evaluation BN for TB domain and the keyjoin query p.Has-strain-ID=a.Strain-ID (FIG. 8b);

FIGS. 9a-9c show results on Census for three query suites; over two, three, and four attributes;

FIGS. 10a-10b show results for two different query suites;

FIG. 10c shows the performance on a third query suite in more detail;

FIG. 11a compares the accuracy of the three methods for various storage sizes on a three attribute query in the TB domain;

FIG. 11b compares the accuracy of the three methods for several different query suites on TB, allowing each method 4.4K bytes of storage;

FIG. 11c compares the accuracy of the three methods for several different query suites on FIN, allowing 2K bytes of storage for each;

FIG. 12a shows the time required by the offline construction phase;

FIG. 12b shows construction time versus dataset size for tree CPD's and table CPD's for fixed model storage size (3.5K bytes); and

FIG. 12c shows experiments that illustrate the dependence.

### DETAILED DESCRIPTION OF THE INVENTION

The invention provides a method and apparatus for automatically constructing a PRM with attribute uncertainty from an existing database. This method provides a completely new way of uncovering statistical dependencies in relational databases. This method is data-driven rather that hypothesis driven and therefore less prone to the introduction of bias by the user.

The invention also provides a method and apparatus for modeling link uncertainty. The method extends the notion of link uncertainty first introduced by Koller and Pfeffer (see D. Koller, A. Pfeffer, Probabilistic framebased systems, Proc. AAAI (1998)). The invention provides a substantial extension of reference uncertainty, which makes it suitable for a learning framework. The invention also provides a new type of link uncertainty, referred to herein as existence uncertainty. A framework for automatically constructing these models from a relational database is also presented.

The invention also provides a technique for constructing a probabilistic relational model of an existing database and using it to perform selectivity estimation for a broad range of queries over the database.

The invention provides a substantial extension of reference uncertainty, which makes it suitable for a learning framework. The invention also provides a new type of link uncertainty, referred to herein as existence uncertainty. A framework is presented for learning these models from a relational database.

The invention also provides a technique for performing selectivity estimation using probabilistic relational models.

Thus, the invention provides:

1. A method for learning probabilistic models from a relational database, and using it for:

a. Reaching conclusions about attributes unobserved in the data

b. Inferring significant statistical patterns present in the data

c. Visualizing the significant dependencies in the data in a graphical form.

d. Approximating the result size of a relational query.

e. Supporting decisions based on these conclusions, such as:

i. Ordering the operations in a complex query, for the purpose of query optimization.

ii. Making decisions about actions relating to individual objects in the database, including medical decisions about patients, marketing decisions about customers, etc.

iii. Classification of objects into multiple different types, based on their attributes and the attributes of the objects to which they are related.

2. Methods for learning probabilistic models of attributes of multiple objects in a relational database (a Probabilistic Relational Model), including any of:

a. Dependencies between attributes of a single object

b. Dependencies between attributes of related objects, whether linked directly or indirectly via a chain of relations.

c. Statistical dependency model for each attribute, as a stochastic function of the other attributes on which is depends.

3. A method as in (2), wherein different possible models are scored using a scoring function that makes use of the entire relational database.

4. The method as in (2), wherein a heuristic search algorithm is used to find a high-scoring function in the space of possible models.

5. Methods for determining the coherence of a PRM, whether learned or constructed by other means, e.g., via elicitation from experts, for guaranteeing that the PRM specifies a consistent probability distribution for any database to which it can be applied. This includes both methods for arbitrary databases, as well as methods for databases that are guaranteed to satisfy prior constraints.

6. Methods for learning a PRM with a probabilistic model over the link structure between objects in the domain. This includes both a model of the presence of a link between two objects, as well as models for the endpoints of such a link.

7. The method as in (6), wherein different possible models are scored using a scoring function that makes use of the entire relational database.

8. The method as in (6), wherein a heuristic search algorithm is used to find a high-scoring function in the space of possible models.

9. Methods for using a PRM with a probabilistic model over link structure for inferring properties of objects (values of attributes of objects) based on the link structure in the model as well as on known properties of objects in the database.

10. The use of a probabilistic graphical model, whether a Bayesian network or a PRM, for evaluating the query result size of a query in a relational database, for the purpose of query optimization, approximate query answering, and other uses.

11. A method as in (10), wherein the same PRM is used to estimate the size of a query over any subset of attributes in said database, and wherein prior information about a query workload is not required.

12. A method as in (11), wherein selectivity estimation is performed for select queries over a single table, and wherein a Bayesian network is used to approximate the joint distribution over an entire set of attributes in said table.

13. A method as in (11), wherein selectivity estimation is performed for queries over multiple tables, and wherein a PRM is used to accomplish both select and join selectivity in a single framework.

14. A method as in (13), wherein selectivity estimation is performed via the construction of a query evaluation Bayesian network from the PRM, for the said query.

15. A method as in (2), wherein the database is such that some of the attribute values are missing, or the database contains hidden attributes, whose values are never observed in the data, or both.

16. A method as in (6), wherein the database is such that some of the attribute values are missing, or the database contains hidden attributes, whose values are never observed in the data, or both.

A key component in many important database tasks is estimating the result size of a query. This is a key component in both query optimization and approximate query answering, In database query optimization, this task is referred to as selectivity estimation. Selectivity estimation is used in query optimization to choose the query plan that minimizes the expected size of intermediate results. One aspect of the invention herein disclosed recognizes that probabilistic relational models (PRMs—discussed below) can be used to perform selectivity estimation. PRMs allow effective estimation of intra-relation correlations of attribute values. In addition, unlike current approaches for selectivity estimation, PRMs allow effective estimation of inter-relation correlations between attribute values. Another important advantage of the invention is that PRMs can also be used to model the join selectivity in the domain explicitly. For example, the disclosure herein shows that a PRM learned from an existing database can significantly outperform traditional approaches to selectivity estimation on a range of queries in four different domains, i.e. one synthetic domain and three real-world domains.

A first aspect of the invention provides a substantial extension of reference uncertainty, which makes it suitable for a learning framework. The invention also provides a new type of link uncertainty, referred to herein as existence uncertainty. A framework is presented for learning these models from a relational database. Finally, the invention also provides a technique for performing selectivity estimation using probabilistic relational models.

The discussion herein begins by reviewing the definition of a probabilistic relational model. We then describe two ways of extending the definition to accommodate link uncertainty. Next, we describe contributions of this invention to learning methods for these models with attribute uncertainty and link uncertainty.

Probabilistic Relational Models

A probabilistic relational model (PRM) specifies a template for a probability distribution over a database. The template includes a relational component that describes the relational schema for a domain, and a probabilistic component that describes the probabilistic dependencies that hold in the domain. A PRM, together with a particular database of objects and relations, defines a probability distribution over the attributes of the objects and the relations.

Relational Schema

A schema for a relational model describes a set of classes, X=X₁, . . . , Xₙ. Each class is associated with a set of descriptive attributes and a set of reference slots. There is a direct mapping between the notion of class and the tables used in a relational database. Descriptive attributes correspond to standard attributes in the table, and reference slots correspond to attributes that are foreign keys, i.e. key attributes of another table.

The set of descriptive attributes of a class X is denoted A(X). Attribute A of class X is denoted X.A, and its domain of values is denoted V(X.A). It is assumed here that domains are finite. For example, the Person class might have the descriptive attributes, such as Sex, Age, Height, and IncomeLevel. The domain for Person.Age might be {child, young-adult, middle-aged, senior}.

The set of reference slots of a class X is denoted R(X). We use similar notation, X.ρ, to denote the reference slot ρ of X. Each reference slot ρ is typed, i.e. the schema specifies the range type of object that may be referenced. More formally, for each ρ in X, the domain type of Dom[ρ]=X and the range type Range[ρ]=Y, where Y is some class in X.

A slot ρ denotes a function from Dom[ρ]=X to Range[ρ]=Y. For example, we might have a class Movie with the reference slot Actor whose range is the class Actor. Or, the class Person might have reference slots Father and Mother whose range type is also the Person class. For each reference slot ρ, we can define an inverse slot ρ⁻¹, which is interpreted as the inverse function of ρ.

Finally, we define the notion of a slot chain, which allows us to compose slots, defining functions from objects to other objects to which they are not directly related. More precisely, we define a slot chain ρ₁, . . . , ρₖ to be a sequence of slots, inverse or otherwise, such that for all I, Range[ρ_{I}]=Dom[ρ_{I}+1].

It is often useful to distinguish between an entity and a relationship, as in entity-relationship diagrams. As used herein, classes represent both entities and relationships. Thus, entities such as actors and movies are represented by classes, but a relationship such as Role, which relates actors to movies, is also represented as a class, with reference slots to the class Actor and the class Movie. This approach, which blurs the distinction between entities and relationships, is common, and allows us to accommodate descriptive attributes that are associated with the relation, such as Role-Type, which might describe the type of role, such as villain, heroine, or extra. We use X_{ε} to denote the set of classes that represent entities, and X_{R} to denote those that represent relationships. Note that the distinctions are prior knowledge about the domain, and are therefore part of the domain specification. We use the generic term object to refer both to entities and to relationships.

The semantics of this language are straightforward. In an instantiation I, each X is associated with a set of objects O′(X). For each attribute AεA(X) and each xεO′(X), I specifies a value X.AεV(X.A). For each reference slot ρεR(X), I specifies a value x.ρεO′(Range[ρ]). For y, εO′(Range[ρ]) we use m y.ρ⁻¹ to denote the set of entities {xεO′(X): x.ρ=y}. The semantics of a slot chain T=ρ₁, . . ., ρₖ are defined via straightforward composition. For AεA(Range[ρₖ]) and xεO′(X), we define x.T.A to be the multiset of values y.A for y in the set x.r.

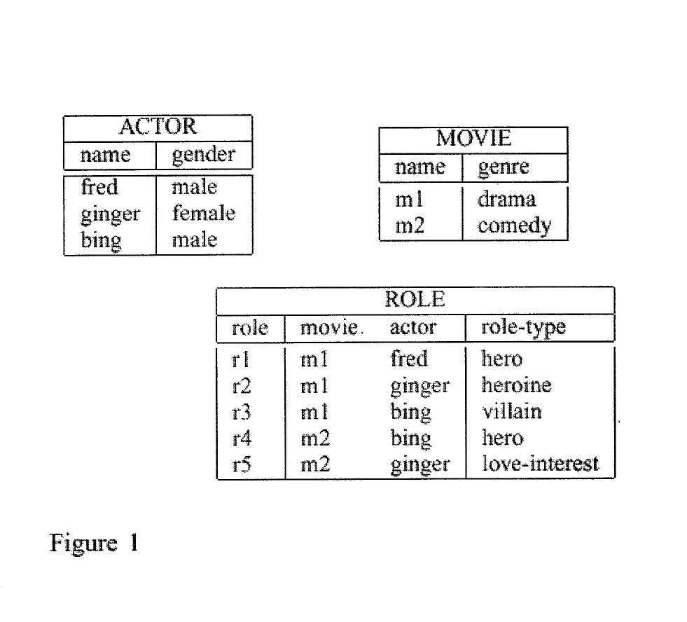

Thus, an instantiation I is a set of objects with no missing values and no dangling references. It describes the set of objects, the relationships that hold between the objects, and all the values of the attributes of the objects. For example, we might have a database containing movie information, with entities Movie, Actor, and Role, which includes the information for all the Movies produced in a particular year by some studio. In a very small studio, we might encounter the instantiation shown in FIG. 1.

As discussed above, one aspect of the invention constructs probabilistic models over instantiations. We shall consider various classes of probabilistic models, which vary in the amount of prior specification on which the model is based. This specification, i.e. a form of skeleton of the domain, defines a set of possible instantiations. The model defines a probability distribution over this set. Thus, we define the necessary building blocks which we use to describe such sets of possible instantiations.

An entity skeleton, σₑ, specifies a set of entities O^{σ}ₑ(X) for each class XεX_{ε}. Our possible instantiations are only those I for which O^{σ}ₑ(X)=O′(X) for each such class X. In the example above, the associated entity skeleton specifies the set of movies and actors in the database: O^{σ}ₑ(Actor)={fred,ginger,bing} and O^{σ}ₑ(Movie)={m1,m2}. The object skeleton is a richer structure. It specifies a set of objects O^{σ}ₑ(X) for each class XεX. In the example, the object skeleton consistent with I specifies the same information as the entity skeleton, as well as the fact that O^{σ}ₑ(Role)={r1,r2,r3,r4,r5}.

This information tells us only the unique identifier, or key, of the different objects, but not how they relate. In effect, in both the entity and object skeletons, we are told only the cardinality of the various classes.

Finally, the relational skeleton, σᵣ, contains substantially more information. It specifies the set of objects in all classes, as well as all the relationships that hold between them. In other words, it specifies O^{σ}(X) for each X, and for each object εO^{σ}(X), it specifies the values of all of the reference slots. In the example above, it provides the values for the actor and movie slots of Role.

Probabilistic Model for Attributes

A probabilistic relational model π specifies probability distributions over all instantiations I of the relational schema. It consists of two components: the qualitative dependency structure, S, and the parameters associated with it, θ_{S}. The dependency structure is defined by associating with each attribute X.A a set of parents Pa(X.A).

A parent of X.A can have the form X.τ.B, for some (possibly empty) slot chain τ. To understand the semantics of this dependence, recall that x.τ.A is a multiset of values S in V(X.τ.A). We use the notion of aggregation from database theory to define the dependence on a multiset. Thus, x.A depends probabilistically on some aggregate property Y′(S). There are many natural and useful notions of aggregation. The discussion of the presently preferred embodiment of the invention presented herein is simplified to focus on particular notions of aggregation., i.e. the median for ordinal attributes and the mode (most common value) for others. We allow X.A. to have as a parent Y′(X.τ.B). For any xεX, x.A depends on the value of Y′(x.τ.B).

The quantitative part of the PRM specifies the parameterization of the model. Given a set of parents for an attribute, we can define a local probability model by associating with it a conditional probability distribution (CPD). For each attribute we have a CPD that specifies P(X.A|Pa(X.A)).

Definition 1: A probabilistic relational model (PRM) π for a relational schema S is defined as follows:

For each class XεX and each descriptive attribute AεA(X), we have:

a set of parents Pa(X.A)={U₁, . . . , U_{I}}, where each U_{I} has the form X.B or X.τ.B, where τ is a slot chain;

a conditional probability distribution (CPD) that represents P_{π}(X.A|Pa(X.A)).

Given a relational skeleton σ_{ρ} a PRM π specifies a probability distribution over a set of instantiations I consistent with σ_{ρ}:

$$P ( I \vert {σ}_{τ} , Π ) = {\prod }_{x} {\prod }_{x ∈ {O}^{τ} + ( X )} {\prod }_{A ∈ A ( X )} P ( x \cdot A \vert Pa ( x \cdot A ) ) \qquad ( 1 )$$

For this definition to specify a coherent probability distribution over instantiations, we must ensure that our probabilistic dependencies are acyclic, so that a random variable does not depend, directly or indirectly, on its own value. To verify acyclicity, we construct an object dependency graph G_{σr}. Nodes in this graph correspond to descriptive attributes of entities. Let X.τ.B be a parent of X.A in our probabilistic dependency schema. For each yεx.τ, we define an edge in G_{σr}:y.B→_{σr}x.A. We say that a dependency structure S is acyclic relative to a relational skeleton σ_{ρ} if the directed graph G_{σr} is acyclic. When G_{σr} is acyclic, we can use the chain rule to ensure that Eq. (1) defines a legal probability distribution as done, for example, in Bayesian networks.

The definition of the object dependency graph is specific to the particular skeleton at hand: the existence of an edge from y.B to x.A depends on whether yεx.τ, which in turn depends on the interpretation of the reference slots. Thus, it allows us to determine the coherence of a PRM only relative to a particular relational skeleton. When we are evaluating different possible PRMs as part of our learning algorithm, we want to ensure that the dependency structure S we choose results in coherent probability models for any skeleton. We provide such a guarantee using a class dependency graph, which describes all possible dependencies among attributes. In this graph, we have an (intra-object) edge X.B→X.A if X.B is a parent of X.A. If Y′(X.τ.B) is a parent of X.A, and Y=Range[τ], we have an (inter-object) edge Y.B→X.A. A dependency graph is stratified if it contains no cycles. If the dependency graph of S is stratified, then it defines a legal model for any relational skeleton σᵣ (see N. Friedman, L. Getoor, D. Koller, A. Pfeffer, Learning probabilistic relational models, Proc. IJCAI (1999)).

Link Uncertainty

In the model described above, all relations between attributes are determined by the relational skeleton σᵣ. Only the descriptive attributes are uncertain. Thus, Eq. (1) determines the likelihood of the attributes of objects, but does not capture the likelihood of the relations between objects. In the following discussion, we extend the probabilistic model to allow for link uncertainty. In this scenario, we do not treat the relational structural as fixed. Rather, we treat the relations between objects as an uncertain aspect of the domain. Thus, we describe a probability distribution over different relational structures. We describe two different dependency models that can represent link uncertainty: Reference Uncertainty and Existence Uncertainty. Each is useful in different contexts, and we note that these two models do not exhaust the space of possible models.

Reference Uncertainty

In this model, we assume that the objects are prespecified, but relations among them, i.e. slot chains, are subject to random choices. More precisely, we are given an object skeleton σᵣ, which specifies the objects in each class. Now, we must specify a probabilistic model not only over the descriptive attributes (as above), but also about the value of the reference slots X.ρ. The domain of a reference slot X.ρ is the set of keys (unique identifiers) of the objects in class Y=Range[ρ]. Thus, we must specify a probability distribution over the set of all objects in a class.

A naive approach is to have the PRM specify a probability distribution directly as a multinomial distribution over O^{σ0}(Y). This approach has two major flaws. This multinomial would be infeasibly large, with a parameter for each object in Y. More importantly, we want our dependency model to be general enough to apply over all possible object skeletons σ₀. A distribution defined in terms of the objects within a specific object skeleton would not apply to others.

We achieve a representation which is both general and compact as follows:

Roughly speaking, we partition the class Y into subsets according to the values of some of its attributes. For example, we can partition the class Movie by Genre. We then assume that the value of X.ρ is chosen by first selecting a partition, and then selecting an object within that partition uniformly. For example, we might assume that a movie theater first selects which genre of movie it wants to show, with a possible bias depending, for example, on the type of theater. It then selects uniformly among the movies with the selected genre. We formalize this intuition by defining, for each slot ρ, a set of partition attributes ψ[ρ] [symbol] A(Y). In the above example, ψ[ρ]={Genre}. Essentially, we specify the distribution that the reference value of ρ falls into one partition versus another. We accomplish this within the framework of the current model by introducing S_{ρ} as a new attribute of X, called a selector attribute. It takes on values in the space of possible instantiations V(ψ[ρ]). Each of its possible value s_{ψ} determines a subset of Y from which the value of ρ (the referent) is selected. More precisely, each value s_{ψ} of S_{ρ} defines a subset Y_{ψ} of the set of objects O^{σ0}(y) : those for which the attributes in ψ[_{ρ}] take the values ψ[ρ]. We use Y_{ψ[ρ]} to represent the resulting partition of O^{σ0}(Y).

We now represent a probabilistic model over the values of ρ by specifying how likely it is to reference objects in one subset in the partition versus another. For example, a movie theater may be more likely to show an action film rather than a documentary film. We accomplish this by introducing a probabilistic model for the selector attribute Sρ. This model is the same as that of any other attribute: it has a set of parents and a CPD. Thus, the CPD for Sρ specifies a probability distribution over possible instantiations s_{ψ}. As for descriptive attributes, we want to allow the distribution of the slot to depend on other aspects of the domain. For example, an independent movie theater may be more likely to show foreign movies, while a megaplex may be more likely to show action films. We accomplish this effect by having parents. In our example, the CPD of S_{Theatre.Current-Movie} might have as a parent Theatre.Type. The choice of value for S_{ρ} determines the partition Y_{ψ} from which the reference value of ρ is chosen. As discussed above, we assume that the choice of reference value for ρ is uniformly distributed within this set.

The random variable S_{ρ} takes on values that are joint assignments to ψ[ρ]. For purposes of the preferred embodiment of the invention, we treat this variable as a multinomial random variable over the cross-product space. In general, however, we can represent such a distribution more compactly, e.g. using a Bayesian network. For example, the genre of movies shown by a movie theater might depend on its type, as above. However, the language of the movie can depend on the location of the theater. Thus, the partition is defined by ψ={Movie.Genre, Movie.Language}, and its parents would be Theatre.Type and Theatre.Location. We can represent this conditional distribution more compactly by introducing a separate variable S_{Movie.Genre}, with a parent Theatre.Type, and another S_{Movie.Language}, with a parent Theatre.Location.

Definition 2: A probabilistic relational model π with reference uncertainty has the same components as in Definition 1. In addition, for each reference slot ρεR(X) with Range[ρ]=Y, we have:

2. a set of attributes ψ[ρ] [symbol] A(Y);

3. a new selector attribute S_{ρ} within X which takes on values in the cross-product space V(ψ[ρ]);

4. a set of parents and a CPD for the new selector attribute, as usual.

To define the semantics of this extension, we must define the probability of reference slots as well as descriptive attributes:

$$\begin{matrix}P ( I \vert {σ}_{o} , Π ) = {\prod }_{X} {\prod }_{z ∈ {O}^{σ} o \int X} {\prod }_{\int A ∈ A ( X )} Pa ( x . A Pa ( x . A ) ) \\ {\prod }_{ρ ∈ R ( x )} \frac{P ( x . {S}_{ρ} = ψ [ x . ρ ] Pa ( X . {S}_{ρ} ) )}{\vert {Y}_{ψ} \vert}\end{matrix} \qquad ( 2 )$$

where we take ψ[x.ρ] to refer to the instantiation ψ of the attributes ψ[ρ] for the object x.ρ in the instantiation I. The last term in Eq. (2) depends on I in three ways: the interpretation of x.ρ, the values of the attributes ψ[ρ] within the object x.ρ, and the size of Y_{ψ}.

This model gives rise to fairly complex dependencies. Consider a dependency of X.A on X.ρ.B. First, note that x.A can depend on y.B for any yεRange[ρ], depending on the choice of value for x.ρ. Thus, the domain dependency graph has a very large number of edges. Second, note that x.A cannot be a parent (or ancestor) of x.ρ. Otherwise, the value of x.A is used to determine the object referenced by x.ρ, and this object in turn affects the value of x.A.

As above, we must guarantee that this complex dependency graph is acyclic for every object skeleton. We accomplish this goal by extending our definition of class dependency graph. The graph has a node for each descriptive or selector attribute X.A. The graph contains the following edges:

For any descriptive or selector attribute C, and any of its parents γ(X.τ.B), we introduce an edge from Y.B to X.G, where Y=Range[τ].

For any descriptive or selector attribute C, and any of its parents γ(X.τ.B), we add the following edges: for any slot ρ, along the chain τ, we introduce an edge from Z.Sρ_{I} to X.C, for Z=Dom[ρ_{I}].

For each slot X.ρ, and each Y.Bεψ[ρ] (for Y=Range[ρ]), we add an edge Y.B-→X.S_{ρ}. This represents the dependence of ρ on the attributes used to partition its range.

The first class of edges in this definition is identical to the definition of dependency graph above, except that it is extended to deal with selector as well as descriptive attributes. Edges of the second type reflect the fact that the specific value of parent for a node depends on the reference values of the slots in the chain. The third type of edges represent the dependency of a slot on the attributes of the associated partition. To see why this is required, we observe that our choice of reference value for x.ρ depends on the values of the partition attributes ψ[X.ρ] of all of the different objects in Y. Thus, these attributes must be determined before x.ρ is determined.

Once again, we can show that if this dependency graph is stratified, it defines a coherent probabilistic model.

Definition 3: Let π be a PRM with relational uncertainty and stratified dependency graph. Let σ₀ be an object skeleton. Then the PRM and σ₀ uniquely define a probability distribution over instantiations I that extend σ₀ via Eq. (2).

Existence Uncertainty

The reference uncertainty model discussed above assumes that the number of objects is known. Thus, if we consider a division of objects into entities and relations, the number of objects in classes of both types are fixed. Thus, we might need to describe the possible ways of relating 5 movies, 15 actors, and 30 roles. The predetermined number of roles might seem a bit artificial because in some domains it puts an artificial constraint on the relationships between movies and actors. If one movie is a big production and involves many actors, this reduces the number of roles that can be used by other movies.

We note that in many real life applications, we use models to compute conditional probabilities. In such cases we compute the probability given a partial skeleton that determines some of the references and attributes in the domain and queries the conditional probability over the remaining aspects of the instance. In such a situation, fixing the number of objects might not seem artificial.

In the following discussion, we consider models where the number of relationship objects is not fixed in advance. Thus, in our example. we consider all 5×15 possible roles, and determine for each whether it exists in the instantiation. In this case, we are given only the schema and an entity skeleton σₑ. We are not given the set of objects associated with relationship classes. We call the entity classes determined and the others undetermined. We note that relationship classes typically represent many-many relationships, i.e. they have at least two reference slots which refer to determined classes. For example, our Role class would have reference slots Actor to Person and In-Movie to Movie. While we know the set of actors and the set of movies, we may be uncertain about which actors have a role in which movie, and thus we have uncertainty over the existence of the Role objects.

In this model, we allow objects whose existence is uncertain. These are the objects in the undetermined classes. One way of achieving this effect is by introducing into the model all of the entities that can potentially exist in it. With each of them we associate a special binary variable that that tells us whether the entity actually exists or not. This construction is conceptual. We never explicitly construct a model containing nonexistent objects. In our example above, the domain of the Role class in a given instantiation I is O^{I}(Person) x O^{I}(Movie). Each potential object x=Role(yₚ,yₘ) in this domain is associated with a binary attribute x.E that specifies whether the person yₚ did or did not see movie m Yₘ.

Definition 4: We define an undetermined class X as follows. Let ρ₁, . . . , ρₖ be the set of reference slots of X, and let Y_{I}=Range[ρ^{I}]. In any instantiation I, we require that O^{I}(X)=O^{I}(Y₁) x ···O^{I}.(Yₖ). For (Y₁, . . . , yₖ)εO^{I}(Y₁) x ···O^{I}(Yₖ), we use X[y₁, . . . , yₖ] to denote the corresponding object in X. Each X has a special existence attribute X.E whose values are V(E)={true,false}. For uniformity of notation, we introduce an attribute for all classes. For classes that are determined, the value is defined to be always true. We require that all of the reference slots of a determined class X have a range type which is also a determined class.

The existence attribute for an undetermined class is treated in the same way as a descriptive attribute in our dependency model, in that it can have parents and children, and is associated with a CPD.

Somewhat surprisingly, our definitions are such that the semantics of the model does not change. More precisely, by defining the existence events to be attributes, and incorporating them appropriately into the probabilistic model, we have set things up so that the semantics of Eq. (1) applies unchanged.

We must place some restrictions on our model to ensure that our definitions lead to a coherent probability model. First, a problem can arise if the range type of a slot of an undetermined class refers to itself, i.e. Range[Xρ]=X. In this case, the set O^{I}(X) is defined circularly, in terms of itself. To ensure semantic coherence, we impose the following restrictions on our models: Let X be an undetermined class. An attribute X.A cannot be an ancestor of X.E. In addition, an object can only exist if all the objects it refers to exist, i.e. for every slot ρεR(X), P(x.E=false|x.ρ.E=false)=1. We also require that dependencies can only pass through objects that exist. For any slot Y.ρ of range-type X, we define the usable slot p-not as follows: for any yεO^{I}(Y), we define y.ρ={xεy.ρ:x.E=true}. We allow only ρ to be used in defining parent slot chains in the dependency model S.

We capture these requirements in our class dependency graph. For every slot ρεR(X) whose range type is Y, we have an edge from Y.E to X.E. For every attribute X.A, every X.ρ₁-not, . . . , ρₖ-not.BεPa(X.A), and every i=1, . . . , k, we have an edge from Range[ρᵢ].E to X.A. As before, we require that the attribute dependency graph is stratified.

It turns out that our requirements are sufficient to guarantee that the entity set of every undetermined entity type is well defined, and allow our extended language to be viewed as a standard PRM. Hence, it follows easily that our extended PRM defines a coherent probability distribution.

Definition 5: Let π be a PRM with undetermined classes and a stratified class dependency graph. Let σₑ be an entity skeleton. Then the PRM and σₑ uniquely define a relational skeletonσ_{τ} over all classes, and a probability distribution over instantiations I that extends σₑ via Eq. (1).

Note that a full instantiation I also determines the existence attributes for undetermined classes. Hence, the probability distribution induced by the PRM also specifies the probability that a certain entity exists in the model.

Real world databases do not specify the descriptive attributes of entities that do not exist. Thus, these attributes are unseen variables in the probability model. Because we only allow dependencies on objects that exist (for which x.E=true), then nonexistent objects are leaves in the model. Hence, they can be ignored in the computation of P(I|σₑ,π). The only contribution of a nonexistent entity x to the probability of an instantiation is the probability that e.E=false.

Learning PRMs

The discussion above concerned three variants of PRM models that differ in their expressive power. Our aim is to learn such models from data. Thus, the task is as follows: given an instance and a schema, construct a PRM that describes the dependencies between objects in the schema. We stress that, when learning, all three variants we described use the same form of training data, i.e. a complete instantiation that describes a set of objects, their attribute values, and their reference slots. However, in each variant, we attempt to learn somewhat different structure from this data. In the basic PRM learning, we learn the probability of attributes given other attributes. In learning PRMs with reference uncertainty, we also attempt to learn the rules that govern the choice of slot references; and in learning PRMs with existence uncertainty, we attempt to learn the probability of existence of relationship objects.

We start by describing the approach (see N. Friedman, L. Getoor, D. Koller, A. Pfeffer, Leaming probabilistic relational models, Proc. IJCAI (1999)) for learning PRMs with attribute uncertainty and then describe modification algorithms for learning PRMs with link uncertainty.

In the previous sections, we defined the PRM language and its semantics. We now move to the task of learning a PRM from data. In the learning problem, our input contains a relational schema, that specifies the basic vocabulary in the domain—the set of classes, the attributes associated with the different classes, and the possible types of relations between objects in the different classes (which simply specifies the mapping between a foreign key in one table and the associated primary key). Our training data consists of a fully specified instance of that schema. We assume that this instance is given in the form of a relational database. Although our approach would also work with other representations. e.g. a set of ground facts completed using the closed world assumption, the efficient querying ability of relational databases is particularly helpful in our framework, and makes it possible to apply our algorithms to large datasets.

There are two variants of the learning task: parameter estimation and structure learning. In the parameter estimation task, we assume that the qualitative dependency structure of the PRM is known; i.e. the input consists of the schema and training database (as above), as well as a qualitative dependency structure ζ. The learning task is only to fill in the parameters that define the CPDs of the attributes. In the structure learning task, there is no additional required input (although the user can, if available, provide prior knowledge about the structure, e.g., in the form of constraints). The goal is to extract an entire PRM, structure as well as parameters, from the training database alone. We discuss each of these problems in turn.

Parameter Estimation

We begin with the parameter estimation task for a PRM where the dependency structure is known. In other words, we are given the structure ζ that determines the set of parents for each attribute, and our task is to learn the parameters

θζ

that define the CPDs for this structure. While this task is relatively straightforward, it is of interest in and of itself. Experience in the setting of Bayesian networks shows that the qualitative dependency structure can be fairly easy to elicit from human experts, in cases where such experts are available. In addition, the parameter estimation task is a crucial component in the structure learning algorithm described in the next section.

The key ingredient in parameter estimation is the likelihood function, the probability of the data given the model. This function measures the extent to which the parameters provide a good explanation of the data. Intuitively, the higher the probability of the data given the model, the better the ability of the model to predict the data. The likelihood of a parameter set is defined to be the probability of the data given the model:

L(θζ|I,σ,ζ)=P(I|σ,ζ,θζ

As in many cases, it is more convenient to work with the logarithm of this function:

$$\begin{matrix}l ( {θ}_{ς} \vert I , σ , ς ) = log P ( I \vert σ , ς , θ ς ) \\ = {\sum }_{Xi} {\sum }_{A ∈ A ( Xi )} [ {\sum }_{χ ∈ ϑ σ ( Xi )} log P ( I χ . A \vert IPa ( χ . A ) ) ] .\end{matrix}$$

The key insight is that this equation is very similar to the log-likelihood of data given a Bayesian network. In fact, it is the likelihood function of the Bayesian network induced by the structure given the skeleton:

the network with a random variable for each attribute of each object x.A, and the dependency model induced by

ζ

and

σ

as discussed. The only difference from standard Bayesian network parameter estimation is that parameters for different nodes in the network—those corresponding to the x.A for different objects x from the same class—are forced to be identical. This similarity allows us to use the well-understood theory of learning from Bayesian networks.

Consider the task of performing maximum likelihood parameter estimation. Here, our goal is to find the parameter setting θζ

L(θζ|I,σ,ζ)

that maximizes the likelihood for a given I,

σ

and

ζ

Thus, the maximum likelihood model is the model that best predicts the training data. This estimation is simplified by the decomposition of log-likelihood function into a summation of terms corresponding to the various attributes of the different classes. Each of the terms in the square brackets can be maximized independently of the rest. Hence, maximum likelihood estimation reduces to independent maximization problems, one for each CPD. In fact, a little further work reduces even further, to a sum of terms, one for each multinomial distribution

θx.A|u.

Furthermore, there is a closed form solution for the parameter estimates. In addition, while we do not describe the details here, we can take a Bayesian approach to parameter estimation by incorporating parameter priors. For an appropriate form of the prior and by making standard assumptions, we can also get a closed form solution for the estimates.

Structure Learning

We now move to the more challenging problem of learning a dependency structure automatically, as opposed to having it given by the user. The main problem here is finding a good dependency structure among the potentially infinitely many possible ones. As in most learning algorithms, there are three important issues that need to be addressed in this setting:

hypothesis space: specifies which structures are candidate hypotheses that our learning algorithm can return;

scoring function: evaluates the “goodness” of different candidate hypotheses relative to the data;

search algorithm: a procedure that searches the hypothesis space for a structure with a high score.

We discuss each of these in turn.

Hypothesis Space

Fundamentally, our hypothesis space is determined by our representation language: a hypothesis specifies a set of parents for each attribute X.A. Note that this hypothesis space is infinite. Even in a very simple schema, there may be infinitely many possible structures. In our genetics example, a person's genotype can depend on the genotype of his parents, or of his grandparents, or of his great-grandparents, etc. While we could impose a bound on the maximal length of the slot chain in the model, this solution is quite brittle, and one that is very limiting in domains where we do not have much prior knowledge. Rather, we choose to leave open the possibility of arbitrarily long slot chains, leaving the search algorithm to decide how far to follow each one.

We must, however, restrict our hypothesis space to ensure that the structure we are learning is a legal one. Recall that we are learning our model based on one training database, but would like to apply it in other settings, with potentially very different relational structure. We want to ensure that the structure we are learning will generate a consistent probability model for any skeleton we are likely to see. As we discussed, we can test this condition using the class dependency graph for the candidate PRM. It is straightforward to maintain the graph during learning, and consider only models whose dependency structure passes the appropriate test.

Scoring Structures

The second key component is the ability to evaluate different structures in order to pick one that fits the data well. We adapt Bayesian model selection methods to our framework. Bayesian model selection utilizes a probabilistic scoring function. In line with the Bayesian philosophy, it ascribes a prior probability distribution over any aspect of the model about which we are uncertain. In this case, we have a prior P(S) over structures, and a prior

P(θζ|ζ)

over the parameters

ζ

given each possible structure. The Bayesian score of a structure is defined as the posterior probability of the structure given the data I. Formally, using Bayes rule, we have that:

P(ζ|I,σ)αP(I|ζ,σ)P(ζ|σ)

where the denominator, which is the marginal probability

P(I|σ)|

is a normalizing constant that does not change the relative rankings of different structures. This score is composed of two main parts: the prior probability of the structure, and the probability of the data given that structure. It turns out that the marginal likelihood is a crucial component, which has the effect of penalizing models with a large number of parameters. Thus, this score automatically balances the complexity of the structure with its fit to the data. In the case where I is a complete assignment, and we make certain reasonable assumptions about the structure prior, there is a closed form solution for the score.

Structure Search

Now that we have a hypothesis space and a scoring function that allows us to evaluate different hypotheses, we need only provide a procedure for finding a high-scoring hypothesis in our space. For Bayesian networks, we know that the task of finding the highest scoring network is NP-hard. As PRM learning is at least as hard as Bayesian network learning (a Bayesian network is simply a PRM with one class and no relations), we cannot hope to find an efficient procedure that always finds the highest scoring structure. Thus, we must resort to heuristic search.

The simplest heuristic search algorithm is greedy hill-climbing search, using our score as a metric. We maintain our current candidate structure and iteratively improve it. At each iteration, we consider a set of simple local transformations to that structure, score all of them, and pick the one with highest score. As in the case of Bayesian networks, we restrict attention to simple transformations such as adding or deleting an edge. We can show that, as in Bayesian network learning, each of these local changes requires that we recompute only the contribution to the score for the portion of the structure that has changed in this step; this has a significant impact on the computational efficiency of the search algorithm. We deal with local maxima using random restarts, i.e., when a local maximum is reached in the search, we take a number of random steps, and the,n continue the greedy hill-climbing process.

There are two problems with this simple approach. First, as discussed in the previous section, we have infinitely many possible structures. Second, even the atomic steps of the search are expensive; the process of computing the statistics necessary for parameter estimation requires expensive database operations. Even if we restrict the set of candidate structures at each step of the search, we cannot afford to do all the database operations necessary to evaluate all of them.

We propose a heuristic search algorithm that addresses both these issues. At a high level, the algorithm proceeds in phases. At each phase k, we have a set of potential parents

Potk(X.A).

for each attribute X.A. We then do a standard structure search restricted to the space of structures in which the parents of each X.A are in

POtk(X.A).

We structure the phased search so that it first explores dependencies within objects, then between objects that are directly related, then between objects that are two links apart, etc. This approach allows us to gradually explore larger and larger fragments of the infinitely large space, giving priority to dependencies between objects that are more closely related. The second advantage of this approach is that we can precompute the database view corresponding to

X.A, Potk(X.A);

most of the expensive computations—the joins and the aggregation required in the definition of the parents—are precomputed in these views. The sufficient statistics for any subset of potential parents can easily be derived from this view. The above construction, together with the decomposability of the score, allows the steps of the search (say, greedy hill-climbing) to be done very efficiently.

Learning with Link Uncertainty

The extension of the Bayesian score to PRMs with existence uncertainty is straightforward. One issue is how to compute sufficient statistics that include existence attributes x.E without explicitly adding all nonexistent entities into the database. This, however, can be done in a straightforward manner. Let μ be a particular instantiation of Pa(X.E). To compute C_{XE}[true,μ], we can use a standard database query to compute how many objects xεO^{σ}(X) have Pa(x.E). To compute C_{XE}[false,μ], we must compute the number of potential entities. We can do this without explicitly considering each (x₁, . . . , xₖ)εO^{I}(Y₁) x ···O^{I}(Yₖ) by decomposing the computation as follows: Let ρ be a reference slot of X with Range[ρ]=Y. Let Pa(X.E) be the subset of parents of X.E along slot ρ and let μ_{ρ} be the corresponding instantiation. We count the number of y consistent with μ_{ρ}. If Pa_{ρ}(X.E) is empty, this count is simply the |O^{I}(Y)|. The product of these counts is the number of potential entities. To compute C_{XE}[false,μ], we subtract C_{X.E}[true,μ] from this number.

The extension required to handle reference uncertainty is also not a difficult one. Once we fix the set partition attributes ψ[ρ], we can treat the variable S_{ρ} as any other attribute in the PRM. Thus, scoring the success in predicting the value of this attribute given the value of its parents is done using the standard Bayesian methods we use for attribute uncertainty, e.g. using a probability distribution such as a standard conjugate Dirichlet prior.

No extensions to the search algorithm are required to handle existence uncertainty. We introduce the new attributes X.E, and integrate them into the search space, as usual. One difference is that we enforce the constraints on the model by properly maintaining the class dependency graph described earlier.

The extension for incorporating reference uncertainty is more subtle. Initially, the partition of the range class for a slot X.ρ is not given in the model. Therefore, we must also search for the appropriate set of attributes ψ[ρ]. We introduce two new operators refine and abstract, which modify the partition by adding and deleting attributes from ψ[ρ]. Initially, ψ[ρ] is empty for each ρ. The refine operator adds an attribute into ψ[ρ]; the abstract operator deletes one.

These newly introduced operators are treated as any other operator in our greedy hill climbing search algorithm. They are considered by the search algorithm at the same time as the standard operators that manipulate edges in the dependency model S. The change in the score is evaluated for each possible operator, and the algorithm selects the best one to execute.

We note that, as usual, the decomposition of the score can be exploited to substantially speed up the search. In general, the score change resulting from an operator ω is reevaluated only after applying an operator ω^{I} that modifies the parent set of an attribute that ω modifies. This is true also when we consider operators that modify the parent of selector attributes and existence attributes.

Result for Learning PRM's with Attribute Uncertainty

Tuberculosis Patient Domain

We applied the algorithm to various real-world domains. The first of these is drawn from a database of epidemiological data for 1300 patients from the San Francisco tuberculosis (TB) clinic, and their 2300 contacts. For the Patient class, the schema contains demographic attributes such as age, gender, ethnicity, and place of birth, as well as medical attributes such as HIV status, disease site (for TB), X-ray result, etc. In addition, a sputum sample is taken from each patient, and subsequently undergoes genetic marker analysis. This allows us to determine which strain of TB a patient has, and thereby create a Strain class, with a relation between patients and strains.

Each patient is also asked for a list of people with whom he has been in contact; the Contact class has attributes that specify the type of contact (sibling, coworker, etc.) contact age, whether the contact is a household member, etc.; in addition, the type of diagnostic procedure that the contact undergoes (Care) and the result of the diagnosis (Result) are also reported. In cases where the contact later becomes a patient in the clinic, we have additional information. We introduce a new class Subcase to represent contacts that subsequently became patients; in this case, we also have an attribute Transmitted which indicates whether the disease was transmitted from one patient to the other, i.e. whether the patient and subcase have the same TB strain.

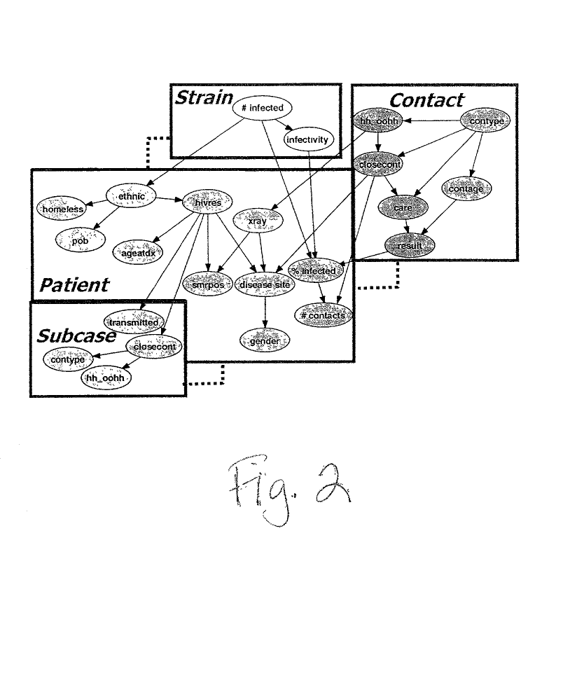

The structure of the learned PRM is shown in FIG. 2. We see that we learn a rich dependency structure both within classes and between attributes in different classes. We showed this model to our domain experts who developed the database, and they found the model quite interesting. They found many of the dependencies to be quite reasonable, for example: the dependence of age at diagnosis (ageatdx) on HIV status (hivres) —typically, HIV-positive patients are younger, and are infected with TB as a result of AIDS; the dependence of the contact's age on the type of contact—contacts who are coworkers are likely to be younger than contacts who are parents and older than those who are school friends; or the dependence of HIV status on ethnicity—Asian patients are rarely HIV positive whereas white patients are much more likely to be HIV positive, as they often get TB as a result of having AIDS. In addition, there were a number of dependencies that they found interesting, and worthy of further investigation. For example, the dependence between close contact (closecont) and disease site was novel and potentially interesting. There are also dependencies that seem to indicate a bias in the contact investigation procedure or in the treatment of TB; for example, contacts who were screened at the TB clinic were much more likely to be diagnosed with TB and receive treatment than contacts who were screened by their private medical doctor. Our domain experts were quite interested to identify these and use them as a guide to develop better investigation guidelines.

We also discovered dependencies that are clearly relational, and that would have been difficult to detect using a non-relational learning algorithm. For example, there is a dependence between the patient's HIV result and whether he transmits the disease to a contact: HIV positive patients are much more likely to transmit the disease. There are several possible explanations for this dependency: for example, perhaps HIV-positive patients are more likely to be involved with other HIV-positive patients, who are more likely to be infected; alternatively, it is also possible that the subcase is actually the infector, and original HIV-positive patient was infected by the subcase and simply manifested the disease earlier because of his immune-suppressed status. Another interesting relational dependency is the correlation between the ethnicity of the patient and the number of patients infected by the strain. Patients who are Asian are more likely to be infected with a strain which is unique in the population, whereas other ethnicities are more likely to have strains that recur in several patients. The reason is that Asian patients are more often immigrants, who immigrate to the U.S.\ with a new strain of TB, whereas other ethnicities are often infected locally.

Company Domain

The second domain we present is a dataset of company and company officers obtained from Security and Exchange Commission (SEC) data. This dataset was developed by Alphatech Corporation based on Primark banking data, under the support of DARPA's Evidence Extraction and Link Discovery (EELD) project. The data set includes information, gathered over a five year period, about companies (which were restricted to banks in the dataset we used), corporate officers in the companies, and the role that the person plays in the company. For our tests, we had the following classes and table sizes: Company (20,000), Person (40,000), and Role (120,000). Company has yearly statistics, such as the number of employees, the total assets, the change in total assets between years, the return on earnings ratio, and the change in return on assets. Role describes information about a person's role in the company including their salary, their top position (president, CEO, chairman of the board, etc.), the number of roles they play in the company and whether they retired or were fired. Prev-Role indicates a slot whose range type is the same class, relating a person's role in the company in the current year to his role in the company in the previous year.

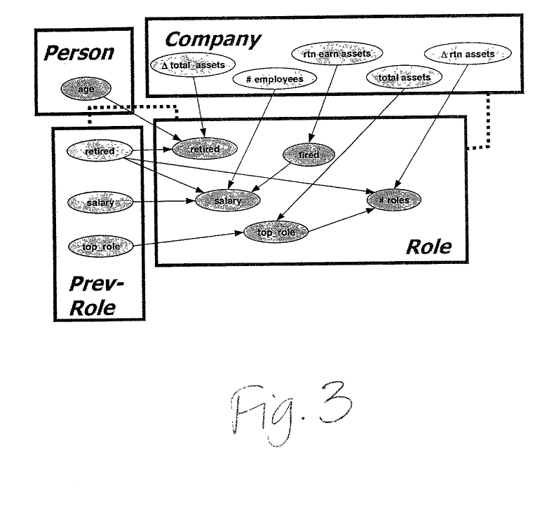

The structure of the learned PRM is shown in FIG. 3. We see that we learn some reasonable persistence arcs such as the facts that this year's salary depends on last year's salary and this year's top role depends on last year's top role. There is also the expected dependence between Person. Age and Role. Retired. A more interesting dependence is between the number of employees in the company, which is a rough measure of company size, and the salary. For example, an employee that receives a salary of $200K in one year is much more likely to receive a raise to $300K the following year in a large bank (over 1000 employees) than in a small one. Again, we see interesting correlations between objects in different relations.

Results for Leaning PRM's with Link Uncertainty

We evaluated the methods on several real-life data sets, comparing standard PRMs, PRMs with reference uncertainty (RU), and PRMs with existence uncertainty (EU). Our experiments used the Bayesian score with a uniform Dirichlet parameter prior with equivalent sample size

α=2,

and a uniform distribution over structures. We first tested whether the additional expressive power allows us to better capture regularities in the domain. Toward this end, we evaluated the likelihood of test data given our learned models. Unfortunately, we cannot directly compare likelihoods, since the PRMs involve different sets of probabilistic events. Instead, we compare the two variants of PRMs with link uncertainty, EU and RU, to “baseline” models which incorporate link probabilities, but make the “null” assumption that the link structure is uncorrelated with the descriptive attributes. For reference uncertainty, the baseline has for each slot. For existence uncertainty, it forces x.E to have no parents in the model.

ψ[ρ]=Φ

We evaluated these different variants on a dataset that combines information about movies and actors from the Internet Movie Database; 1990-2000 Internet Movie Database Limited, and information about people's ratings of movies from the Each Movie dataset; http://www.research.digital.com/SRC/EachMovie, where each person's demographic information was extended with census information for their zipcode. From these, we constructed five classes (with approximate sizes shown): Movie (1600), Actor (35,000); Role (50,000), Person (25,000), and Vote (300,000).

We modeled uncertainty about the link structure of the classes Role (relating actors to movies) and Vote (relating people to movies). This was done either by modeling the probability of the existence of such objects, or modeling the reference uncertainty of the slots of these objects. We trained on nine-tenths of the data and evaluated the log-likelihood of the held-out test set. Both models of link uncertainty significantly outperform their “baseline” counterparts. In particular, we obtained a log-likelihood of −210,044 for the EU model, as compared to −213,798 for the baseline EU model. For RU, we obtained a log-likelihood of −149,705 as compared to −152,280 for the baseline model. Thus, we see that the model where the relational structure is correlated with the attribute values is substantially more predictive than the baseline model that takes them to be independent: although any particular link is still a low-probability event, our link uncertainty models are much more predictive of its presence.

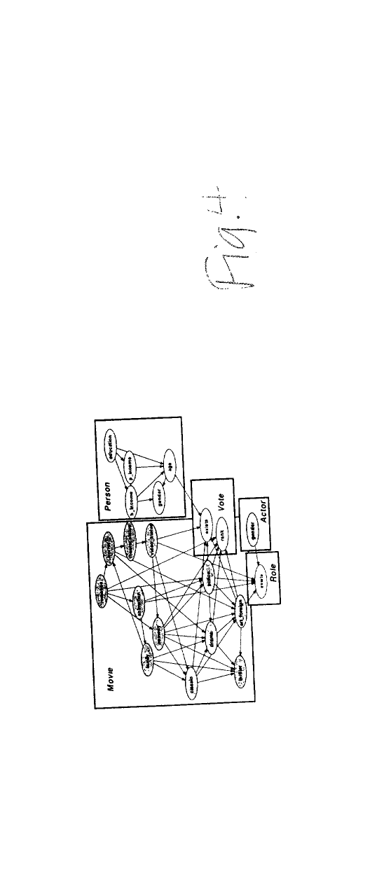

FIG. 4 shows the EU model learned. We learned that the existence of a vote depends on the age of the voter and the movie genre, and the existence of a role depends on the gender of the actor and the movie genre. In the RU model (figure omitted due to space constraints), we partition each of the movie reference slots on genre attributes; we partition the actor reference slot on the actor's gender; and we partition the person reference of votes on age, gender and education. An examination of the models shows, for example, that younger voters are much more likely to have voted on action movies and that male action movies roles are more likely to exist than female roles.

Next, we considered the conjecture that by modeling link structure we can improve the prediction of descriptive attributes. Here, we hide some attribute of a test-set object, and compute the probability over its possible values given the values of other attributes on the one hand, or the values of other attributes and the link structure on the other. We tested on two similar domains: Cora and WebKB . The Cora dataset contains 4000 machine learning papers, each with a seven-valued Topic attribute, and 6000 citations. The WebKB dataset contains approximately 4000 pages from several Computer Science departments, with a five-valued attribute representing their “type”, and 10,000 links between web pages. In both datasets we also have access to the content of the document (webpage/paper), which we summarize using a set of attributes that represent the presence of different words on the page (a binary Naive Bayes model). After stemming and removing stop words and rare words, the dictionary contains 1400 words in the Cora domain, and 800 words in the WebKB domain.

In both domains, we compared the performance of models that use only word appearance information to predict the category of the document with models that also used probabilistic information about the link from one document to another. We fixed the dependency structure of the models, using basically the same structure for both domains. In the Cora EU model, the existence of a citation depends on the topic of the citing paper and the cited paper. We evaluated two symmetrical RU models. In the first, we partition the citing paper by topic, inducing a distribution over the topic of Citation. Citing. The parent of the selector variable is Citation. Cited. Topic. The second model is symmetrical, using reference uncertainty over the cited paper.

Table 1 shows prediction accuracy on both data sets. We see that both models of link uncertainty significantly improve the accuracy scores, although existence uncertainty seems to be superior. Interestingly, the variant of the RU model that models reference uncertainty over the citing paper based on the topics of papers cited (or the from webpage based on the categories of pages to which it points) outperforms the cited variant. However, in all cases, the addition of citation/hyperlink information helps resolve ambiguous cases that are misclassified by the baseline model that considers words alone. For example, paper #506 is a Probabilistic Methods paper, but is classified based on its words as a Genetic Algorithms paper (with probability 0.54). However, the paper cites two Probabilistic Methods papers, and is cited by three Probabilistic Methods papers, leading both the EU and RU models to classify it correctly. Paper #1272 contains words such as rule, theori, refin, induct, decis, and tree. The baseline model classifies it as a Rule Learning paper (probability 0.96). However, this paper cites one Neural Networks and one Reinforcement Learning paper, and is cited by seven Neural Networks, five Case-Based Reasoning, fourteen Rule Learning, three Genetic Algorithms, and seventeen Theory papers. The Cora EU model assigns it probability 0.99 of being a Theory paper, which is the correct topic. The first RU model assigns it a probability 0.56 of being Rule Learning paper, whereas the symmetric RU model classifies it correctly. We explain this phenomenon by the fact that most of the information in this case is in the topics of citing papers; it appears that RU models can make better use of information in the parents of the selector variable than in the partitioning variables.

| | Cora | WebKB |
|---|---|---|
| Baseline | 75 +/− 2.0 | 74 +/− 2.5 |
| RU Citing | 81 +/− 1.7 | 78 +/− 2.3 |
| RU Cited | 79 +/− 1.3 | 77 +/− 1.5 |
| EU | 85 +/− 0.9 | 82 +/− 1.3 |

We learned a PRM for this domain using our two different methods for modeling link uncertainty. For reference uncertainty, the model we learn (π_{RU}) allows uncertainty over the Movie and Actor reference slots of Role, and the Movie and Person reference slots of Votes. For existence uncertainty, the model we learn (π_{EU}) allows uncertainty over the existence of Role, and the existence of Votes.

Applications of PRM Learning

Applications of the invention herein disclosed include, for example, the following:

Data exploration, e.g. discovering significant patterns in the data; data summarization, e.g. compact summary of large relational database; inference, e.g. reasoning about important unobserved attributes; clustering, e.g. discovering clusters of entities that are similar; anomaly detection, e.g. finding unusual elements in data; learning complex structures; finding hidden variables, e.g. relational clustering; causality; finding structural signatures in graphs; acting under uncertainty in complex domains; planning; and reinforcement learning.

With regard to biomedical data sets, information is typically richly structured and relational, comprising data from clinical, demographic, genetic, and epidemiological sources. Traditional approaches work with a flat representation, and assume fixed length attribute-value vectors and independent identically distributed (IID) samples. As discussed above, problems attendant with such approaches include flattening, which introduces statistical skew, loses relational structure, and is incapable of detecting link-based patterns. Other problems with such approaches include those of analysis), i.e. testing of expert-defined hypotheses. Such systems are laborious, unsystematic, and often comprise a biased process. It is difficult to implement such approaches when less domain expertise available, e.g. with regard to genomics. Thus, one goal of the invention is to learn a statistical model from relational data. Applications of the invention to biological data sets include, for example, the areas of:

Tuberculosis research;

HIV mutation and drug resistance; and

Gene expression pathways.

Selectivity Estimation using Probabilistic Relational Models

Accurate estimates of the result size, i.e. selectivity, of queries are crucial to several query processing components of a database management system (DBMS). Cost-based query optimizers use intermediate result size estimates to choose the optimal query execution plan. Query profilers provide feedback to a DBMS user during the query design phase by predicting resource consumption and distribution of query results. Precise selectivity estimates also allow efficient load balancing for parallel joins on multiprocessor systems. Selectivity estimates can also be used to approximately answer counting, i.e. aggregation, queries.

The result size of a selection query over multiple attributes is determined by the joint frequency distribution of the values of these attributes. The joint distribution encodes the frequencies of all combinations of attribute values. Thus, representing the joint distribution exactly becomes infeasible as the number of attributes and values increases. Most commercial systems approximate the joint distribution by adopting several key assumptions. These assumptions allow fast computation of selectivity estimates but, as many have noted, the estimates can be quite inaccurate.

The first common assumption is the attribute value independence assumption, under which the distributions of individual attributes are independent of each other and the joint distribution is the product of single-attribute distributions. However, as is well known, real data often contain strong correlations between attributes that violate this assumption, thereby leading approaches that make this assumption to make very inaccurate approximations. For example, in a medical database, the Patient table might contain highly correlated attributes, such as Gender and HIV-status. The attribute value independence assumption grossly overestimates the result size of a query that asks for HIV-positive women.

A second common assumption is the join uniformity assumption, which assumes that a tuple from one relation is equally likely to join with any tuple from the second relation. Again, there are many situations in which this assumption is violated. For example, assume that our medical database has a second table for medications that the patients receive. HIV-positive patients receive more medications than the average patient. Therefore, a tuple in the medication table is much more likely to join with a patient tuple of an HIV-positive patient, thereby violating the join uniformity assumption. If we consider a query for the medications provided to HIV-positive patients, an estimation procedure that makes the join uniformity assumption is likely to underestimate its size substantially.

To relax these assumptions, we need a more refined approach, that takes into consideration the joint distribution over multiple attributes, rather than the distributions over each attribute in isolation. Several approaches to joint distribution approximation have been proposed recently. Among them are multidimensional histograms (see, for example, M. Muralikrishna, D. J. Dewitt, Equi-depth histograms for estimating selectivity factors for multi-dimensional queries, Proc. of ACM SIGMOD Conf, pp. 28-36 (1988) and V. Poosala, Y. loannidis, Selectivity estimation without the attribute value independence assumption, M. Jarke, M. Carey, K. Dittrich, F. Lochovsky, P, Loucopoulos, M. Jeusfeld, eds., VLDB'97, Proceedings of 23rd International Conference on Very Large Data Bases, Aug. 25-29, 1997, Athens, Greece, pp. 486-495, Morgan Kaufmann (1997)) and wavelets (see, for example, Y. Matias, J. Vitter, M. Wang, Wavelet-based histograms for selectivity estimation, L. Haas, A. Tiwary, eds., SIGMOD 1998, Proceedings ACM SIGMOD International Conference on Management of Data, Jun. 2-4, 1998, Seattle, Wash., USA, pp. 448-459, ACM Press (1998); J. Vitter, M. Wang, Approximate computation of multidimensional aggregates of sparse data using wavelets, A. Delis, C. Faloutsos, S. Ghandeharizadeh, eds., SIGMOD 1999, Proceedings ACM SIGMOD International Conference on Management of Data, Jun. 1-3, 1999, Philadelphia, Pa., USA, pp. 193-204, ACM Press (1999); and K. Chakrabarti, M. Garofalakis, R. Rastogi, K. Shim, Approximate query processing using wavelets, A. E I Abbadi, M. Brodie, S. Chakravarthy, U. Dayal, N. Kamel, G. Schlageter, K.-Y. Whang, eds., VLDB 2000, Proceedings of 26th International Conference on Very Large Data Bases, Sep. 10-14, 2000, Cairo, Egypt, pp. 111-122, Morgan Kaufmann (2000)). This embodiment of the invention provides an alternative approach for the selectivity, i.e. query-size, estimation problem, based on techniques from the area of probabilistic graphical models (see, for example, M. I. Jordan, ed., Learning in Graphical Models, Kluwer, Dordrecht, Netherlands (1998) and J. Pearl, Probabilistic Reasoning in Intelligent Systems, Morgan Kaufmann (1988)). The invention provides several important advantages. First, it provides a uniform framework for select selectivity estimation and foreign-key join selectivity estimation, thereby providing a systematic approach for estimating the selectivity of queries involving both operators. Second, the invention is not limited to answering a small set of predetermined queries. A single statistical model can be used to estimate the sizes of any (select foreign-key join) query effectively, over any set of tables and attributes in the database.

Probabilistic graphical models are a language for compactly representing complex joint distributions over high-dimensional spaces. The basis for the representation is a graphical notation that encodes conditional independence between attributes in the distribution. Conditional independence arises when two attributes are correlated, but the interaction is mediated via one or more other variables. For example, in a medical database, gender is correlated with HIV status, and gender is correlated with smoking. Hence, smoking is correlated with HIV status, but only indirectly. Interactions of this type are extremely common in real domains. Probabilistic graphical models exploit the conditional independence that exist in a domain, and thereby allow us to specify joint distributions over high dimensional spaces compactly.

The presently preferred implementation of this embodiment of the invention provides a framework for using probabilistic graphical models to estimate selectivity of queries in a relational database. As discussed below, Bayesian networks (BNs) see, for example, J. Pearl, Probabilistic Reasoning in Intelligent Systems, Morgan Kaufmann (1988)) can be used to represent the interactions between attributes in a single table, thereby providing high-quality estimates of the joint distribution over the attributes in that table. Probabilistic relational models (PRMs), which are discussed in detail above (see, for example, D. Koller, A. Pfeffer, Probabilistic frame-based systems, Proc. AAAI (1998)), extend Bayesian networks to the relational setting. PRMs allow us to represent skew in the join probabilities between tables, as well as correlations between attributes of tuples joined via a foreign-key. They thereby allow us to estimate selectivity of queries involving both selects and foreign-key joins over multiple tables.

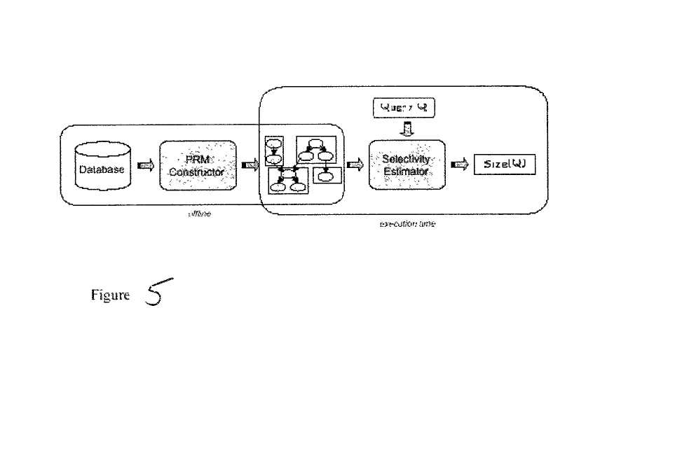

FIG. 5 shows the high-level architecture for the presently preferred algorithm.

There are two key phases:

The first phase is the construction of a PRM from the database. The PRM is constructed automatically, based solely on the data and the space allocated to the statistical model. The construction procedure is executed offline, using an effective procedure whose running time is linear in the size of the data. We describe the procedure as a batch algorithm, however it is possible to handle updates incrementally.

The second phase is the online selectivity estimation for a particular query. The selectivity estimator receives as input a query and a PRM, and outputs an estimate for the result size of the query. Note that the same PRM is used to estimate the size of a query over any subset of the attributes in the database. We are not required to have prior information about the query workload.

Finally, we provide empirical validation of our approach, and compare it to some of the most common existing approaches. We present experiments over several real-world domains, showing that our approach provides much higher accuracy in a given amount of space than previous approaches, at a very reasonable computational cost, both offline and online.

Estimation for Single Table Queries

We first consider estimating the result size for select queries over a single relation. We focus on queries with equality predicates of the form attribute=value. Our approach can easily be extended to apply to a richer class of queries. More precisely, let R be some table. We use R.* to denote the value (non-key) attributes A₁, . . . , Aₙ, of R. Consider a query Q over some set of attributes A₁, . . . , Aₖ [symbol] R.*, which is a conjunction of selections of the form A_{I}=vᵢ. We denote the joint frequency distribution over A₁, . . . , Aₖ as F_{D}(A₁, . . . , Aₖ). It is convenient to deal with the normalized frequency distribution P_{D}(A₁, . . . , Aₖ) where:

P_{D}(A₁, . . . , Aₖ)=F_{D}(A₁, . . . , Aₖ)/|R|.

This transformation allows us to treat P_{D} (A₁, . . . , Aₖ) as a probability distribution. Let L_{Q} be the event that the equalities in Q hold for r. It is clear that the size of the result of the query Q is:

size_{Q}[D]=F_{D}(Q)=|R|·P_{D}(L_{Q}),

where F_{D}(Q) is the number of tuples satisfying Q and P_{D}(L_{Q}) is the probability, relative to D, of the event L_{Q}. To simplify notation, we often use P_{D}(Q). As the size of the relation is known, the joint probability distribution contains all the n ecess ary information for query size estimation. Hence, we largely restrict attention to the joint probability distribution.

The distribution P_{D}(A₁, . . . , Aₖ) is a projection of the joint distribution over the entire set A₁, . . . , Aₙ of value attributes of R. We can define this joint distribution P_{D}(A₁, . . . , Aₙ) directly from the data via an imaginary process, where we sample a tuple r from R, and then select as the values of A₁, . . . , Aₙ the values of r.A₁, . . . , r.Aₙ. Thus, this process induces a joint distribution P_{D}(A₁, . . . , Aₖ) over the values of A₁, . . . , Aₖ. Note that we are not suggesting that the sampling process used to define P_{D} be carried out in practice. We are merely using it as a way of defining P_{D}.

Unfortunately, the number of entries in this joint distribution grows exponentially in the number of attributes, so that explicitly representing the joint distribution P_{D} is almost always intractable. Several approaches have been proposed to circumvent this issue by approximating the joint distribution, or projections of it, using a more compact structure. See below for further discussion. We also propose the use of statistical models that approximate the full joint distribution. However, to represent the distribution in a compact manner, we exploit the conditional independence that often holds in a joint distribution over real world data. By decomposing the representation of a joint distribution into factors that capture the independence that hold in the domain, we get a compact representation for the distribution.

Conditional Independence

Consider a simple relation R with the following three value attributes, each with its value domain shown in parentheses: Education (high-school, college, advanced-degree), Income (low, medium, high), and Horne-Owner (false, true). As shorthand, we use the first letter in each of these names to denote the attribute. We also use capital letters for the attributes and lower case letters for particular values of the attributes. In addition, we use P(A) to denote a probability distribution over the possible values of attribute A , and P(a) to denote the probability of the event A=a.

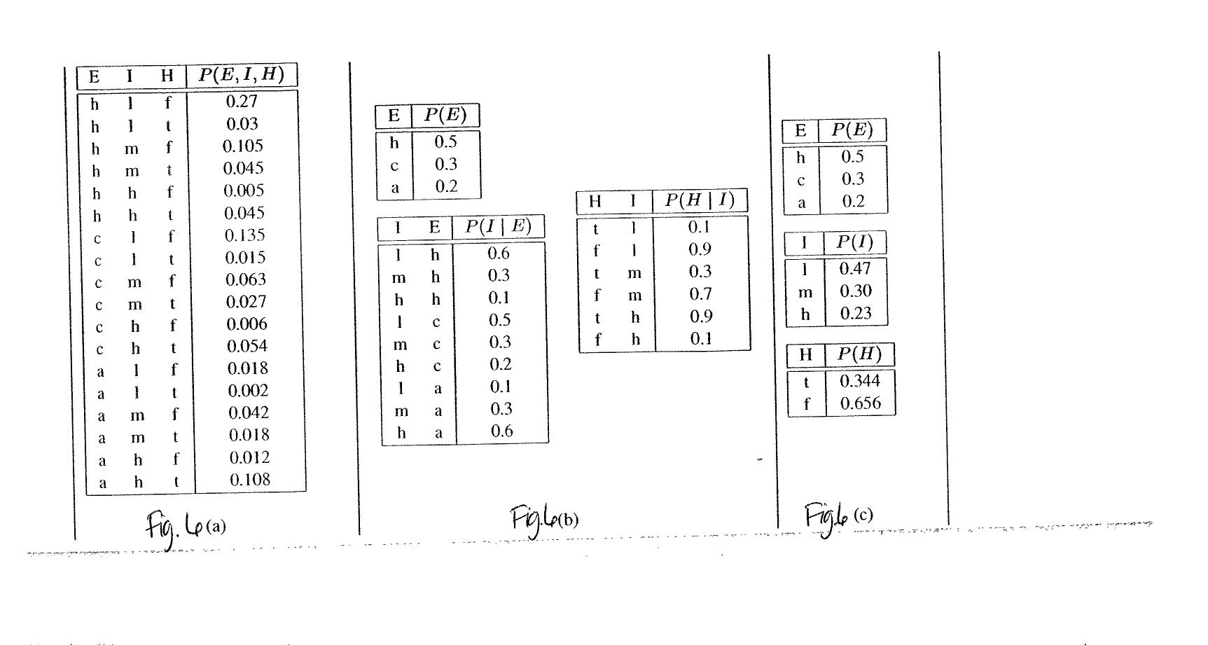

Assume that the joint distribution of attribute values in our database is as shown in FIG. 6(a). Using this joint distribution, we can compute the selectivity of any query over E, I, and H. As shorthand, we use Qₑₜₕ to denote a select query of the form E=e, I=i, H=h. Then sizeQₑₜₕ[D]=|R|·P(e,i,h). However, to represent the joint distribution we explicitly must store eighteen numbers, one for each possible combination of values for the attributes. In fact, we can get away with seventeen numbers because we know that the entries in the joint distribution must sum to one.

In many cases, however, our data exhibit a certain structure that allows us to represent the distribution approximately using a much more compact form. The intuition is that some of the correlations between attributes might be indirect ones, mediated by other attributes. For example, the effect of education on owning a home might be mediated by income: a high-school dropout who owns a successful Internet startup is more likely to own a home than a highly educated beach bum—the income is the dominant factor, not the education. This assertion is formalized by the statement that Home-owner is conditionally independent of Education given Income, i.e. for every combinations of values h,e,i, we have that:

P(H=h|E=e, I=i)=P(H=h|I=i).

This assumption does, in fact, hold for the distribution of FIG. 6. The conditional independence assumption allows us to represent the joint distribution more compactly in a factored form. Rather than representing P(E,I,H), we represent: the marginal distribution over Education—P(E); a conditional distribution of Income given Education—P(I|E); and a conditional distribution of Home-owner given Income—P(H|I. It is easy to verify that this representation contains all of the information in the original joint distribution, if the conditional independence assumption holds:

P(H,E,I)=P(E)P(I|E)P(H|I,E)=P(E)P(I|E)P(H|I)

where the last equality follows from the conditional independence of E and H given I.

In our example, the joint distribution can be represented using the three tables shown in FIG. 6(b). It is easy to verify that they do encode precisely the same joint distribution as in FIG. 6(a).

The storage requirement for the factored representation seems to be 3+9+6=18, as before. In fact, if we account for the fact that some of the parameters are redundant because the numbers must add up to 1, we get 2+6+3=11, as compared to the 17 we had in the full joint. While the savings in this case may not seem particularly impressive, savings grow exponentially as the number of attributes increases, as long as the number of direct dependencies remains bounded.

Note that the conditional independence assumption is very different from the standard attribute independence assumption. In this case, for example, the one-dimensional histograms, i.e. marginal distributions, for the three attributes are shown in FIG. 6(c). It is easy to see that the joint distribution that we would obtain from the attribute independence assumption in this case is very different from the true underlying joint distribution. It is also important to note that our conditional independence assumption is compatible with the strong correlation that exists between Home-owner and Education in this distribution. Thus, conditional independence is very different from independence.

Bayesian Networks

Bayesian networks (BNs) (see, for example, J. Pearl, Probabilistic Reasoning in Intelligent Systems, Morgan Kaufmann (1988)) are compact graphical representations for high-dimensional joint distributions. They exploit the underlying structure of the domain—the fact that only a few aspects of the domain affect each other directly. We consider probability spaces defined as the set of possible assignments to the set of attributes A₁, . . . , Aₙ of a relation R. BNs are a compact representation of a joint distribution over A₁, . . . , Aₙ. They use a structure that exploits conditional independence among attributes, thereby taking advantage of the locality of probabilistic influences.

A Bayesian network B consists of two components:

The first component G is a directed acyclic graph whose nodes correspond to the attributes A₁, . . . , Aₙ. The edges in the graph denote a direct dependence of an attribute A₁ on its parents Parents (A₁). The graphical structure encodes a set of conditional independence assumptions: each node A₁ is conditionally independent of its non-descendants given its parents.

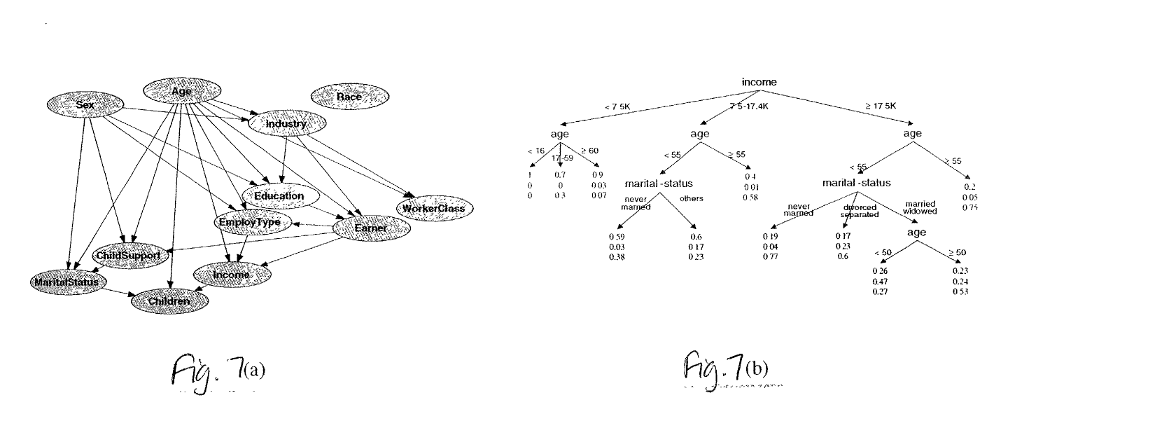

FIG. 7(a) shows a Bayesian network constructed from data obtained from the 1993 Current Population Survey (CPS) of U.S. Census Bureau using their Data Extraction System (DES) (see U.S. Census Bureau, Census bureau databases, http://www.census.gov). In this case, the table contains twelve attributes: Age, Worker-Class, Education, Marital-Status, Industry, Race, Sex, Child-Support, Earner, Children, Total-income, and Employment-Type. The domain sizes for the attributes are, respectively: 18, 9, 17, 7, 24, 5, 2, 3, 3, 42, and 4. This BN was constructed automatically from the database, the construction algorithm which is described below. We see, for example, that the Children attribute, representing whether or not there are children in the household, depends on other attributes only via the attributes Total-income, Age, and Marital-Status. Thus, Children is conditionally independent of all other attributes given Total-income, Age, and Marital-Status.

The second component of a BN describes the statistical relationship between each node and its parents. It consists of a conditional probability distribution (CPD) (discussed above) P_{B}(A_{I}|Parents(A_{I})) for each attribute, which specifies the distribution over the values of A_{I} given any possible assignment of values to its parents. This CPD may be represented in a number of ways. It may be represented as a table, as in our earlier example. Alternatively, it can be represented as a tree, where the interior vertices represent splits on the value of some parent of A_{I}, and the leaves contain distributions over the values of A_{I}. In this representation, we find the conditional distribution over A_{I} given a particular choice of values Aₖ₁=a₁, . . . , Aₖᵢ=a_{I} for its parents by following the appropriate path in the tree down to a leaf: When we encounter a split on some variable Akⱼ, we go down the branch corresponding to the value of a_{I}. We then use the distribution stored at that leaf. The CPD tree for the Children attribute in the network of FIG. 7(a) is shown in FIG. 7(b). The possible values for this attribute are N/A, Yes, and No. We can see, for example, that the distribution over Children given Income≧17.5K, Age<55, and Marital-Status=never married is (0.19, 0.04, 0.77). By contrast, the distribution over Children given Income≧17.5K, Age<50, and Marital-Status=married is (0.26, 0.47, 0.27) The distribution of Children given Income≧17.5K, Age<50, and Marital-Status=widowed is the same, because the two instantiations lead to the same induced path down the tree.

The conditional independence assumptions associated with the BN B, together with the CPDs associated with the nodes, uniquely determine a joint probability distribution over the attributes via the chain rule:

$${P}_{B} ( {A}_{i} … {A}_{n} ) = {\prod }_{i - 1}^{n} {P}_{B} ( {A}_{i} \vert Parents ( {A}_{i} ) )$$

This formula is precisely analogous to the one used above. Thus, from our compact model, we can recover the joint distribution. We do not need to represent it explicitly. In our example above, the number of entries in the full joint distribution is approximately 70 billion, while the number of parameters in our BN is 150. This is a significant reduction.

BNs for Query Estimation

The conditional independence assertions correspond to equality constraints on the joint distribution in the database table. In general, these equalities rarely hold exactly. In fact, even if the data were generated by independently generating random samples from a distribution that satisfies conditional independence (or even unconditional independence) assumptions, the distribution derived from the frequencies in our data does not satisfy these assumptions. However, in many cases we can approximate the distribution very well using a Bayesian network with the appropriate structure. A longer discussion of this issue is provided below.

A Bayesian network is a compact representation of a full joint distribution. Hence, it implicitly contains the answer to any query about the probability of any assignment of values to a set of attributes. Thus, if we construct a BN B that approximates P_{D}, we can easily use it to estimate P_{D},(Q) for any query Q over R. Assume that our query Q has the form r.A=a (here we abbreviate a multidimensional select using vector notation). Then we can compute:

F_{D}(A=a)=|R|·P_{D}(Q)≈|R|·P_{B}(A=a)

Generating the full joint distribution P_{B} can be computationally very expensive, and is almost always infeasible in the runtime setting in which query size is typically estimated. Thus, we need a more efficient algorithm for computing P_{B}(A=a). Although the problem of computing this probability is NP-hard (that, computationally challenging) in the worst case, BN inference is typically very efficient for network structures encountered in practice. The standard BN inference algorithms (see, for example, S. Lauritzen, D. Spiegelhalter, Local computations with probabilities on graphical structures and their application to expert systems, Journal of the Royal Statistical Society, B 50, 2, pp.157-224 (1988)) use special-purpose graph-based algorithms that exploit the graphical structure of the network. The complexity of these algorithms depends on certain natural parameters relating to the connectivity of the graph. These parameters are typically small for most real-world models, allowing very effective inference for many networks with hundreds of nodes or more (see, for example, D. Heckerman, J. Breese, K. Rommelse, Troubleshooting under uncertainty, Technical Report MSR-TR-94-07, Microsoft Research (1994) and M. Pradhan, G. Provan, B. Middleton, M. Henrion, Knowledge engineering for large belief networks., Proceedings of the Tenth Annual Conference on Uncertainty in Artificial Intelligence (UAI '94), pp. 484-490 (1994)).

Selectivity Estimation with Joins

The discussion above restricted attention to queries over a single table. In the following discussion, we extend our approach to deal with queries over multiple queries. We restrict attention to databases satisfying referential integrity. Let R be a table, and let F be a foreign key in R that refers to some table S with primary key K. Then for every tuple rεR there must be some tuple sεS such that r.F=s.K. For purposes of the discussion herein, we restrict attention to foreign key joins, i.e. joins of the form r.F=s.K. We use the term keyjoin as a shorthand for this type of join.

Joining Two Tables

Consider a medical database with two tables: Patient, containing tuberculosis (TB) patients, and Contact, containing people with whom a patient has had contact, and who may or may not be infected with the disease. We might be interested in answering queries involving a join between these two tables. For example, we might be interested in the following query:

patient.Age=over-60, contact.Of-patient-ID=patient.Patient-ID, contact.Contype=roommate,

i.e. finding all patients whose age is over 60 who have had contact with a roommate.

A simple approach to this problem would behave as follows: By referential integrity, each tuple in Contact must join with exactly one tuple in Patient. Therefore, the size of the joined relation, prior to the selects, is |Contact|. We then compute the probability p of Patient.Age=over-60 and the probability q of Contact.Contype=roommate, and estimate the size of the resulting query as |contact|·p·q.

This naive approach is flawed in two ways: First, the attributes of the two different tables are often correlated. In general, foreign keys are often used to connect tuples in different tables that are semantically related, and hence the attributes of tuples related through foreign key joins are often correlated. For example, there is a clear correlation between the age of the patient and the type of contacts they have. In fact, elderly patients with roommates are quite rare, and this naive approach would grossly overestimate their number. Second, the probability that two tuples join with each other can also be correlated with various attributes. For example, middle-aged patients typically have more contacts than older patients. Thus, while the join size of these two tables, prior to the selection on patient age, is |Contact|, the fraction of the joined tuples where the patient is over 60 is lower than the overall fraction of patients over 60 within the Patient table.

We address these issues by providing a more accurate model of the joint distribution of these two tables. Consider two tables R and S such that R.F, points to S.K. We define a joint probability space over R and S using an imaginary sampling process that randomly samples a tuple r from R and independently samples a tuple s from S. The two tuples may or may not join with each other. We introduce a new join indicator variable to model this event. This variable J_{RS}, is binary valued. It is true when r.F=s.K and false otherwise.

This sampling process induces a distribution P_{D}(J_{RS}, A₁, . . . , Aₙ, B₁, . . . , Bₘ), over the values of the join indicator J_{RS}, the value attributes R.*={A₁, . . . , Aₙ} and the value attributes S.*=B₁, . . . , Bₘ. Now, consider any select-keyjoin query Q over R and S:r.A=a, s.B=b, r.F=s.K (where again we abbreviate a multidimensional select using vector notation). It is easy to see that the size of the result of Q is:

sizeQ|D|=Fσ(Q)=|R−S|−Pσ(A=a, B=b, JRS=true) (3)

In other words, we can estimate the size of any query of this form using the joint distribution P_{D} defined using our sampling process. As we now show, an extension of the techniques described above allow us to estimate this joint distribution using a probabilistic graphical model.

Probabilistic Relational Models

Probabilistic relational models (PRMs) are discussed above (see, for example, D. Koller, A. Pfeffer, Probabilistic frame-based systems, Proc. AAAI (1998)) and extend Bayesian networks to the relational setting. They allow us to model correlations not only between attributes of the same tuple, but also between attributes of related tuples in different tables. This extension is accomplished by allowing, as a parent of an attribute R.A , an attribute S.B in another relation S such that R has a foreign key for S. We can also allow dependencies on attributes in relations that are related to R via a longer chain of joins. To simplify the notation, we omit the description.

The basic PRM framework was concerned only with computing probabilities of queries conditioned on the assumption that tuples in different tables joined up correctly. In our setting, we are also interested in computing the probability of the join event itself. Hence, we augment PRMs with join indicator variables, as described above.

Definition 3.1: A probabilistic relational model (PRM) π for a relational database is a pair (S,θ), which specifies a local probabilistic model for each of the following variables:

5. for each table R and each attribute AεR.* a variable R.A;

6. for each foreign key F of R into S, a Boolean join indicator variable R.J_{RS}.

For each variable of the form R.X:

S specifies a set of parents Parents(R.X), where each parent has the form R.B or R.F.B where F is a foreign key of R into some table S and B is an attribute of S;

θ specifies a CPD P(R.X|Parents R.X)).

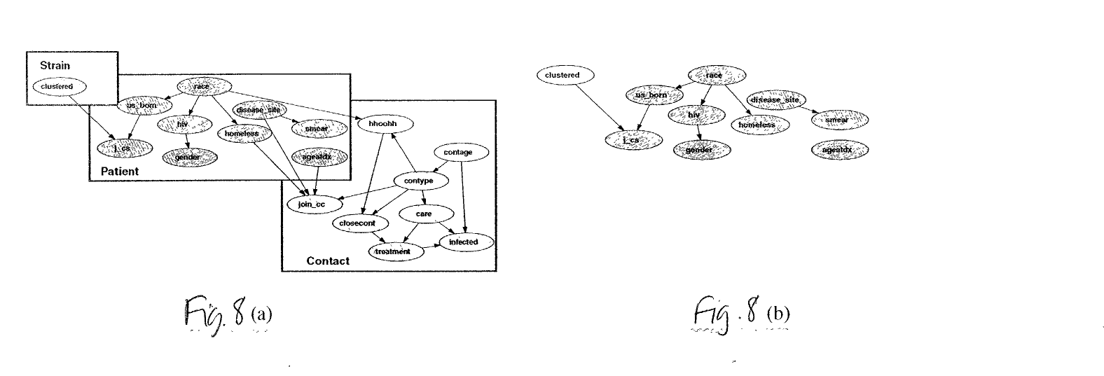

As discussed above, the PRM model also allows dependencies between the attributes of related tuples. For example, consider the PRM for our TB domain, shown in FIG. 8(a). Here, we have that the type of the contact depends on the age and gender of the patient. However, we do not want an attribute r.A to depend on s.B unless r and s are related to each other. Because we are trying to model a distribution where r and s are chosen independently at random, such a dependence would not make sense. Hence, we allow r.A to depend on s.B only if r.F=s.K. This assumption can be represented as simple constraints on the dependency model and CPDs. For S we require that if R.F.B is a parent of R.A, then R.J_{RS} must also be a parent of R. For θ we require that the CPD is only defined for cases where R.J_{RS}=true. In other words, in the CPD tree for R.A, R.J_{RS} is at the root of the tree, and only the fork in which R.J_{RS}=true is meaningful.

Note that the join indicator variable also has parents and a CPD. Indeed, consider the PRM for our TB domain. The join indicator variable Patient.J._{CS} has the parents Patient.USBorn and Strain.Unique, which indicates whether the strain is unique in the population or has appeared in more than one patient. There are essentially three cases: for a non-unique strain and a patient that was born outside the U.S., the probability that they join is around 0.001; for a non-unique strain and a patient born in the U.S. the probability is 0.0029, nearly three times as large; for a unique strain, the probability is 0.0004, regardless of the patient's place of birth. Thus, we are much more likely to have U.S.-born patients joining to non-unique strains than foreign-born ones. The reason is that foreign-born patients often immigrate to the U.S. already infected with the disease. Such patients typically have a unique strain indigenous to their region. U.S.-born patients, on the other hand, are much more likely to contract the disease by catching it from someone local, and therefore appear in infection clusters.

Selectivity Estimation using PRMs

We now wish to describe the relationship between a PRM model and the database. In the case of BNs, the connection was straightforward: the BN B_{R} is an approximation to the frequency distribution P_{D}. In the case of PRMs, the issue is more subtle, as a PRM does not describe a distribution over a single table in isolation. The probability distribution of an attribute can depend on parents that are attributes in other, foreign-key related tuples. We therefore need to define a joint probability distribution over a tuple r together with all tuples on which it depends. To guarantee that the set of tuples we must consider is finite, we place a stratification restriction on our PRM models.

Definition 3.2: Let < be a partial ordering over the tables in our database. We say that a foreign key R.F, that connects to S is consistent with <if <R..A PRM π is (table) stratified if there exists a partial ordering < such that whenever R.F.B is a parent of some R.A, where F is a foreign key into S, S<R.

We can now define the minimal extension to a query Q. Let Q be a keyjoin query over the tuple variables r₁, . . . , rₖ (which may or may not refer to the same tables).

Definition 3.3: Let Q be a keyjoin query. We define the upward closure Q⁺ for Q to be the minimal query that satisfies the following two conditions:

5 1. Q⁺ contains all of the join operations in Q.

2. For each r, if there is an attribute R.A with parent R.F.B, where R.F, points to S, then there is a unique tuple variable s in Q⁺ for which Q⁺ contains the join constraint r.F=s.K.

It is clear that we can construct the upward closure for any query and that this set is finite. For example, if our query Q in the TB domain is over a tuple variable c from the Contact, then Q⁺ is over the three tuple variables c, p, s where p is a tuple variable over Patient and s is a tuple variable over Strain. Note that there is no direct dependence of attributes of Contact on attributes of Strain, but there are dependencies on Patient, and the introduction of the tuple variable p in turn necessitated the introduction of another tuple variable s. Note that, if we consider a keyjoin query Q′ that already contains a tuple variable p with the constraint c.Of-patient-ID=p.Patient-ID, then the closure of Q′ is identical to the closure of Q; i.e. the process does not introduce a new tuple variable if a corresponding one is already present.

We can extend the definition of upward closure to select-keyjoin queries in the following way: the select clauses are not relevant to the notion of upward closure.

We note that upward closing a query does not change its result size:

Definition 3.4: Let q be a query and let Q⁺ be its upward closure. Then

sizes_{Q}[D]=size_{Q+}[D]

This result follows immediately from the referential integrity assumption.

Let Q be a keyjoin query, and let Q⁺ be its upward closure. Let r₁, . . . , rₖ be the tuple variables in Q⁺. Let P_{D}(r₁, . . . , rₖ) be the distribution obtained by sampling each tuple r₁, . . . , rₖ independently, as described above. Then for any query Q′ which extends Q⁺, the PRM allows us to approximate P_{D}(I_{Q′}), precisely the quantity required for estimating the query selectivity. We can compute the PRM estimate using the following simple construction:

Definition 3.5: Let π=(S,θ) be a PRM over D, and let S be an keyjoin query. We define the query-evaluation Bayesian network B_{π}[Q] to be a BN as follows:

7. It has a noder.A for every rεQ⁺ and attribute AεR.*. It also has a node r.Jᵣₛ for every clause r.F=s.K in Q⁺.

8. For every variable r.X, the node r.X has the parents specified in Parents (r.X) in S: If R.B is a parent of R.A, then r.B is a parent of r.A; if R.F.B is a parent of R.A, then s.B is a parent of r.A where s is the unique tuple variable for which Q⁺ asserts that r.F=s.K.

9. The CPD of r.X is as specified in θ.

For example, FIG. 8(b) shows the query evaluation BN for the upwardly closed keyjoin query p.Has-strain-ID=s.Strain-ID.

We can now use this Bayesian network to estimate the selectivity of any query. Consider a select-keyjoin query Q′ which extends the keyjoin query Q. We can estimate P_{D}(Q′) by computing P_{Bπ[q]}(I_{Q′}+), where I_{r.A=a} is itself (as above), and I_{r.F=s.K} is r.Jᵣₛ=true. For example, to evaluate the probability of the query p.Age=over-60, we would use the BN in FIG. 8(b) (as it upward closes p), and compute the probability of (p.Age=over-60, p.Has-strain-ID′=s.Strain-ID).

Constructing a PRM from a Database

The discussion above shows how we can perform query size estimation once we have a PRM that captures the significant statistical correlations in the data distribution. The following discussion addresses the question of how to construct such a model automatically from the relational database.

The input to the construction algorithm consists of two parts: a relational schema, that specifies the basic vocabulary in the domain—the set of tables, the attributes associated with each of the tables, and the possible foreign key joins between tuples; and the database itself, which specifies the actual tuples contained in each table.

In the construction algorithm, our goal is to find a PRM (S,θ) that best represents the dependencies in the data. To provide a formal specification for this task, we first need to define an appropriate notion of best. Given this criterion, the algorithm tries to find the model that optimizes it. There are two parts to our optimization problem:

10. The parameter estimation problem: for a given dependency structure S, we must find the best parameter set θ;

11. The structure selection problem: find the dependency structure S that, with the optimal choice of parameters, achieves the maximal score, subject to our space constraints on the model.

Scoring Criterion

To provide a formal definition of model quality, we make use of basic concepts from information theory (see, for example, T. Cover, J. Thomas, Elements of Information Theory, Wiley (1991)). The quality of a model can be measured by the extent to which it summarizes the data. In other words, if we had the model, how many bits would be required, using an optimal encoding, to represent the data. The more informative the model, the fewer bits are required to encode the data.

It is well known that the optimal Shannon encoding of a data set, given the model, uses a number of bits which is the negative logarithm of the probability of the data given the model. In other words, we define the score of a model (S,θ) using the following log-likelihood function:

l(θ,ζ|D)=log P(D|ζ,θ) (4)

We can therefore formulate the model construction task as that of finding the model that has maximum log-likelihood given the data.

We note that this criterion is different from t hose used in the standard formulations of learning probabilistic models from data (see, for example, D. Heckerman, A tutorial on learning with Bayesian networks, M. I. Jordan, ed., Learning in Graphical Models, MIT Press, Cambridge, Mass. (1998)). In the latter cases, we typically choose a scoring function that trades off fit to data with model complexity. This tradeoff allows us to avoid fitting the training data too closely, thereby reducing our ability to predict unseen data. In this case, our goal is very different: We do not want to generalize to new data, but only to summarize the patterns in the existing data. This difference in focus is what motivates our choice of scoring function.

Parameter Estimation

We begin by considering the parameter estimation task for a given dependency structure. In other words, having selected a dependency structure S that determines the set of parents for each attribute, we must fill in the numbers θ that parameterize it. The parameter estimation task is a key subroutine in the structure selection step: to evaluate the score for a structure, we must first parameterize it. In other words, the highest scoring model is the structure whose best parameterization has the highest score.

It is well-known that the highest likelihood parameterization for a given structure S is the one that precisely matches the frequencies in the data. More precisely, consider some attribute A in table R and let X be its parents in S . Our model contains a parameter θ_{a|x} for each value a of A and each assignment of values x to X. This parameter represents the conditional probability P(R.A=a|X=x). The maximum likelihood value for this parameter is simply the relative frequency of R.A=a within the population of cases X=x:

$${θ}_{ax}^{0} = \frac{{P}_{σ} ( R . A = a \vert X = x )}{{F}_{σ} ( X = x )} \qquad ( 5 )$$

The frequencies, or counts, used in this expression are called sufficient statistics in the statistical learning literature.

This computation is very simple in the case where the attribute and its parents are in the same table. For example, to compute the CPD associated with the Patient.Gender attribute in our TB model, we execute a count and group-by query on Gender, and HIV, which gives us the counts for all possible values of these two attributes. These counts immediately give us the sufficient statistics in both the numerator and denominator of the entire CPD. This computation requires time which is linear in the amount of data in the table.

The case where some of the parents of an attribute appear in a different table is only slightly more complex. Recall that we restricted dependencies between tuples to those that utilize foreign-key joins. In other words, we can have r.A depending on s.B only if r.F=s.K for a foreign key F, in R which is also the primary key of S. We enforced this requirement by forcing the join indicator J_{RS} variable to be a parent of R.A whenever R.A has a parent S.B, and requiring that the tree-CPD for R.A not allow a dependency on S.B if J_{RS}=false.

Thus, to compute the CPD for R.A that depends on S.B, we execute a foreign-key join between R and S, and then use the same type of count and group-by query over the result. For example, in our TB model, Contact.Age has the parents Contact.Contype and Contact.Of-patient-ID.Age. To compute the sufficient statistics, we simply join Patient and Contact on Patient.Patient-ID=Contact.Of-patient-ID, and then group and count appropriately.

We have presented this analysis for the case where R.A depends only on a single foreign attribute S.B. However, the discussion clearly extends to dependencies on multiple attribute, including within different tables. We simply do all of the necessary foreign-key joins, generate a single result table over R.A and all of its parents X, and compute the sufficient statistics.

While this process might appear expensive at first glance, it can be executed very efficiently. Recall that we are only allowing dependencies via foreign-key joins. Putting that restriction together with our referential integrity assumption, we know that each tuple r joins with precisely a single tuple s. Thus, the number of tuples in the resulting join is precisely the size of R. The same observation holds when R.A has parents in multiple tables, so we have to perform several join operations. Assuming that we have a good indexing structure on keys, e.g. a hash index, the cost of performing the join operations is therefore also linear in the size of R.

Finally, we must discuss the computation of the CPD for a join indicator variable J_{RS}. In this case, we must compute the probability that a random tuple r from R and a random tuple s from S satisfies r.F=s.K. As we discussed, we are allowing the probability of the join event to depend on values of attributes in rand s, e.g. on the value of r.A and s.B. In our TB domain, the join indicator between Patient and Strain depends on USBorn within the Patient table and on Unique within the Strain table.

To compute the sufficient statistics for P(J_{RS}|r.A, s.B), we need to compute the total number of cases where r.A=a, s.B=b, and then the number within those where r.F=s.K. Fortunately, this computation is also easy. The first is F_{D}(R.A=a)·F_{D}(S.B=b). The latter is F_{D}(R.A=a,S.B=b, R.F=S.K), which can be computed by joining the two tables and then doing a count and group-by query. The cost of this operation (assuming an appropriate index structure) is again linear in the number of tuples in R and in S.

Structure Selection

Our second task is the structure selection task: finding the dependency structure that achieves the highest log-likelihood score. The problem here is finding the best dependency structure among the superexponentially many possible ones. If we have m attributes in a single table, the number of possible dependency structures is 2^{O(m2logm)}. If we have multiple tables, the expression is slightly more complicated, because not all dependencies between attributes in different tables are legal. This is a combinatorial optimization problem, and one which is known to be NP-hard see, for example, D. Chickering, Learning Bayesian networks is NP-complete, D. Fisher, H.-J. Lenz, eds., Learning from Data: Artificial Intelligence and Statistics V, Springer Verlag (1996)). We therefore provide an algorithm that finds a good dependency structure using simple heuristic techniques; despite the fact that the optimal dependency structure is not guaranteed to be produced, the algorithm nevertheless performs very well in practice.

Scoring Revisited

The log-likelihood function can be reformulated in a way that both facilitates the model selection task and allows its effect to be more easily understood. We first require the following basic definition (see, for example, T. Cover, J. Thomas, Elements of Information Theory, Wiley (1991)):

Definition 4.1: Let Y and Z be two sets of attributes, and consider some joint distribution P over their union. We can define the mutual information of Y and Z relative to P as:

$${MI}_{P} ( Y ; Z ) = {E}_{P} [ log \frac{P ( y , z )}{P ( \tilde{y} , Z )} ] = {\sum }_{y , z} P ( y , z ) log \frac{P ( y , z )}{P ( \tilde{y} , Z )}$$

where

\tilde{P}(y,z)=P(y)P(z).

The term inside the expectation is the logarithm of the relative error between P(y,z) and an approximation to it

\overline{r}

that makes y an z independent, but maintains the probability of each one. The entire expression is simply a weighted average of this relative error over the distribution, where the weights are the probabilities of the events y, z.

It is intuitively clear that mutual information is measuring the extent to which Y and Z are correlated in P. If they are independent, then the mutual information is zero. Otherwise, the mutual information is always positive. The stronger the correlation, the larger the mutual information.

Consider a particular structure S. Our analysis above specifies the optimal choice (in terms of likelihood) for parameterizing S. We use θ_{S} to denote this set of parameters. Let P_{D} be the distribution in the database, as above. We can now reformulate the log-likelihood score in terms of mutual information:

$$l ( ς , {θ}_{ς} \vert D ) = [ {\sum }_{i} \vert {R}_{i} \vert {\sum }_{A ∈ {R}_{1}^{*}} {MI}_{{P}_{D}} ( {R}_{i} . A ; Pa ( {R}_{i} . A ) ) ] + C \qquad ( 5 )$$

where C is a constant that does not depend on the choice of structure. Thus, the overall score of a structure decomposes as a sum, where each component is local to an attribute and its parents. The local score depends directly on the mutual information between a node and its parents in the structure. Thus, our scoring function prefers structures where an attribute is strongly correlated with its parents. We use score_{I}(S:D) to denote I(s,θ_{S}|D).

Model Space

An important design decision is the space of dependency structures that we are allowing the algorithm to consider. Several constraints are imposed on us by the semantics of our models. Bayesian networks and PRMs only define a coherent probability distribution if the dependency structure is acyclic, i.e. there is no directed path from an attribute back to itself. Thus, we restrict attention to dependency structures that are directed acyclic graphs. Furthermore, we have placed certain requirements on inter-table dependencies: a dependency of R.A on S.B is only allowed if S.K is a foreign key in R, and if the join indicator variable J_{RS} is also a parent of R.A, and plays the appropriate role in the CPD tree. Finally, we have required that the dependency structure be stratified along tables, as specified above.

A second set of constraints is implied by computational considerations. A database system typically places a bound on the amount of space required to specify the statistical model. We therefore place a bound on the size of the models constructed by our algorithm. In our case, the size is typically the number of parameters used in the CPDs for the different attributes, plus some small amount required to specify the structure. A second computational consideration is the size of the intermediate group-by tables constructed to compute the CPDs in the structure. If these tables get very large, storing and manipulating them can get expensive. Therefore, we often choose to place a bound on the number of parents per node.

Search Algorithm

Given a set of legal candidate structures, and a scoring function that allows us to evaluate different structures, we need only provide a procedure for finding a high-scoring hypothesis in our space. The simplest heuristic search algorithm is greedy hill-climbing search, using random restarts to escape local maxima. We maintain our current candidate structure S and iteratively improve it. At each iteration, we consider a set of simple local transformations to that structure. For each resulting candidate successor S′, we check that it satisfies our constraints, and select the best one. We restrict attention to simple transformations such as adding or deleting an edge, and adding or deleting a split in a CPD tree. This process continues until none of the possible successor structures S′ have a higher score than S. At this point, the algorithm can take some number of random steps, and then resume the hill-climbing process. After some number of iterations of this form, the algorithm halts and outputs the best structure discovered during the entire process.

One important issue to consider is how to choose among the possible successor structures S′ of a given structure S. The most obvious approach is to simply choose the structure S′ that provides the largest improvement in score, i.e. that maximizes Δ_{I}(S′,S)=score_{I}(S′:D)−score_{I}(S:D). However, this approach is very shortsighted, as it ignores the cost of the transformation in terms of increasing the size of the structure. We now present two approaches that address this concern. In the discussion below, we compare the empirical performance of the naive approach as well as these two extensions.

The first approach is based on an analogy between this problem and the weighted knapsack problem: We have a set of items, each with a value and a volume, and a knapsack with a fixed volume. Our goal is to select the largest value set of items that fits in the knapsack. Our goal here is very similar: every edge that we introduce into the model has some value in terms of score and some cost in terms of space. A standard heuristic for the knapsack problem is to greedily add the item into the knapsack that has, not the maximum value, but the largest value to volume ratio. In our case, we can similarly choose the edge for which the likelihood improvement normalized by the additional space requirement:

$${Δ}_{n} ( {ς}^{1} , ς ) = \frac{{Δ}_{l} ( {ς}^{1} , ς )}{space {ς}^{1} - space ( ς )}$$

We refer to this method of scoring as storage size normalized (SSN). This heuristic has provable performance guarantees for the knapsack problem. Unfortunately, in our problem the values and costs are not linearly additive, so there is no direct mapping between the problems and the same performance bounds do not apply.

The second idea is to use a modification to the log-likelihood scoring function called MDL (minimum description length). This scoring function is motivated by ideas from information and coding theory. It scores a model using not simply the negation of the number of bits required to encode the data given the model, but also the number of bits required to encode the model itself. This score has the form:

score_{mdl}(ζ:D)=l(ζ,θ_{ζ}|D)−space(ζ)

We defineΔₘ(ζ¹,ζ)=score_{mdl}(ζ¹:D)−score_{mdl}(ζ:D)

All three approaches involve the computation of Δ_{I} (S′,S). Eq. (6) then provides a key insight for improving the efficiency of this computation. As we saw, the score decomposes into a sum, each of which is associated only with a node and its parents in the structure. Thus, if we modify the parent set or the CPD of only a single attribute, the terms in the score corresponding to other attributes remain unchanged (see, for example, D. Heckerman, A tutorial on learning with Bayesian networks, M. I. Jordan, ed., Learning in Graphical Models, MIT Press, Cambridge, Mass. (1998)). Thus, to compute the score corresponding to a slightly modified structure, we need only recompute the local score for the one attribute whose dependency model has changed. Furthermore, after taking a step in the search, most of the work from the previous iteration can be reused.

To understand this idea, assume that our current structure is S. To do the search, we evaluate a set of changes to S, and select the one that gives us the largest improvement. Say that we have chosen to update the local model for R.A (either its parent set or its CPD tree). The resulting structure is S′. Now, we are considering possible local changes to S′. The key insight is that the component of the score corresponding to another attribute S.B has not changed. Hence, the change in score resulting from the change to S.B is the same in SÃ and in S′, and we can reuse that number unchanged. Only changes to R.A need to be re-evaluated after moving to S′.

Other Approaches

Selectivity estimation has been the focus of much of the work in cost-based query optimization (see, for example, Y. Ioannidis, Query optimization, ACM Computing Surveys, 28(1):121-123 (1996)). Recently, research effort has turned to the task approximate query processing in OLAP. Both tasks rely on fast and accurate data reduction techniques. Barbara et al. (see, for example, D. Barbara, W. DuMouchel, C. Faloutsos, P. Haas, J. Hellerstein, Y. Ioannidis, H. Jagadish, T. Johnson, R. Ng, V. Poosala, K. Ross, K. Sevcik, The new jersey data reduction report, Data Engineering Bulletin, 20(4):3-45 (1997)) give an excellent summary of approaches to data reduction. Here, we describe briefly describe previous approaches to the general problem of data reduction, however we concentrate on approaches that have been used for selectivity estimation.

Select Selectivity Estimation

Most of the work on query selectivity estimation has focused on the task of select selectivity within a single table. Work in this area has been quite active in the last few years, with several different approaches suggested.

One approach for approximate the query size is via random sampling (see, for example, R. Lipton, J. Naughton, D. Schneider, Practical selectivity estimation through adaptive sampling, H, Garcia-Molina, H. Jagadish, eds., Proceedings of the 1990 ACM SIGMOD International Conference on Management of Data, Atlantic City, N.J., May 23-25, 1990, pp. 1-11, ACM Press (1990)). Here, a set of samples is generated, and then the query result size is estimated by computing the actual query result size relative to the sampled data. An advantage of this approach is that it can handle any select query. A disadvantage is that online random sampling can be expensive computational, and random sampling is not commonly used for selectivity estimation. However, even neglecting the computational expense of sampling, as we will see below, the number of sample tuples required for accurate estimation can be large.

More recently, several approaches have been proposed that attempt to capture the joint distribution over attributes more directly. The earliest of these is multidimensional histograms (see, for example M. Muralikrishna, D. Dewitt, Equi-depth histograms for estimating selectivity factors for multi-dimensional queries, Proc. of ACM SIGMOD Conf, pp. 28-36 (1988) and V. Poosala, Y. Ioannidis, Selectivity estimation without the attribute value independence assumption, M. Jarke, M. Carey, K. Dittrich, F. Lochovsky, P, Loucopoulos, M. Jeusfeld, eds., VLDB'97, Proceedings of 23rd International Conference on Very Large Data Bases, Aug. 25-29, 1997, Athens, Greece, pp. 486-495, Morgan Kaufmann (1997)). Poosala supra. provides an extensive exploration of the taxonomy of methods for construction multidimensional histograms and study the effectiveness of different techniques. They also propose an approach based on SVD. However, this approach is only applicable in the two-dimensional case. In our experiments discussion, we compare our results to using multidimensional histograms. Even for simple select queries over just a few attributes of a relation, our method gives improved accuracy using less storage space.

A newer approach is the use of wavelets to approximate the underlying joint distribution. Approaches based on wavelets have been used both for selectivity estimation (see, for example, Y. Matias, J. t Vitter, M. Wang, Wavelet-based histograms for selectivity estimation, L. Haas, A. Tiwary, eds., SIGMOD 1998, Proceedings ACM SIGMOD International Conference on Management of Data, Jun. 2-4, 1998, Seattle, Wash., USA, pp. 448-459, ACM Press (1998)) and for approximate query answering (see, for example, J. Vitter, M. Wang, Approximate computation of multidimensional aggregates of sparse data using wavelets, A. Delis, C. Faloutsos, S. Ghandeharizadeh, eds., SIGMOD 1999, Proceedings ACM SIGMOD International Conference on Management of Data, Jun. 1-3, 1999, Philadelphia, Pa., USA, pp. 193-204, ACM Press (1999) and K. Chakrabarti, M. Garofalakis, R. Rastogi, K. Shim, Approximate query processing using wavelets, A. El Abbadi, M. Brodie, S. Chakravarthy, U. Dayal, N. Kamel, G. Schlageter, K.-Y. Whang, eds., VLDB 2000, Proceedings of 26th International Conference on Very Large Data Bases, Sep. 10-14, 2000, Cairo, Egypt, pp. 111-122, Morgan Kaufmann (2000)). They compare to favorably to random sampling. While we have not done a direct comparison, however we think that the results that we have gotten in similar domains (Census), indicate that our methods are certainly competitive.

Join Selectivity

Much less work has been done on estimating the selectivity of joins. Commercial DBMSs commonly make the uniform join assumption. Approaches that utilize random sampling have been suggested, however there are several well known difficulties with sampling. First, there is the problem that the join of two uniform random samples of a base relation is not a uniform sample of the join relaxation. Second, there is the problem that the join of two random samples is typically very small. An alternative recent approach is the work of Acharya et al. (see, for example, S. Acharya, P. Gibbons, V, Poosala, S. Ramaswamy, Join synopses for approximate query answering, A. Delis, C. Faloutsos, S. Ghandeharizadeh, eds., SIGMOD 1999, Proceedings ACM SIGMOD International Conference on Management of Data, Jun. 1-3, 1999, Philadelphia, Pa., USA, pp. 275-286, ACM Press (1999)) on join synopses. By maintaining statistics for a few distinguished joins, they are able to overcome many of the difficulties of join selectivity estimation. In some respects, our work is in a similar spirit, although our models apply to a wider range of schemas. In addition, our model construction algorithm uses score to automatically guide its search through the space of possible join dependencies to model rather than relying on guidance from the user.

Unified Framework

An important benefit of our approach is the provision of a unified framework for both select and join selectivity estimation. To our knowledge, there is no research that provides selectivity estimates to queries containing both select and join operations in real domains. While in the experimental results section, we break down our comparisons in terms of either select or join operations, it is important not to lose sight of the fact that our method allows selectivity estimations to be done for a broad range of queries that do not have to be prespecified by the user.

Experimental Results

In the discussion below, we present experimental results for a variety of real-world data, including: a census dataset (see, for example, U.S. Census Bureau, Census bureau databases, http://www.census.gov); a subset of the database of financial data used in the 1999 European KDD Cup (see, for example, P. Berka, Pkdd99 discovery challenge, http://lisp.vse.cz/pkdd99/chall.htm (1999)); a database of tuberculosis patients in San Francisco (see, for example, M. Behr, M. Wilson, W. Gill, H. Salamon, G. Schoolnik, S. Rane, P. Small, Comparative genomics of BCG vaccines by whole genome DNA microarray, Science, 284:1520-23 (1999) and M. Wilson, J. DeRisi, H. Kristensen, P. Imboden, S. Rane, P. Brown, G. Schoolnik, Exploring drug-induced alterations in gene expression in Mycobacterium tuberculosis by microarray hybridization, Proceedings of the National Academy of Sciences (2000)); We ran our experiments on two datasets from the census database: (Census92) Population Survey for 92 (a subset of four attributes, approximately 150 k tuples) and (Census93) Population Survey for 92 (a subset of twelve attributes, approximately 150 k tuples). The financial data (FIN) has three tables, with the following sizes: Account (4.5 k tuples), Transaction (106 k tuples) and District (77 tuples). The tuberculosis data (TB) also has three tables, with the following sizes: Patient (2.5 k tuples), Contact (19 k tuples) and Strain (2 k tuples).

In this section, we present experimental results for a variety of real-world data, including: a census dataset; a subset of the database of financial data used in the 1999 European KDD Cup; and a database of tuberculosis patients in San Francisco. We begin by evaluating the accuracy of our methods on select queries over a single relation. We then consider more complex, select-join queries over several relations. Finally, we discuss the running time for construction and estimation for our models.

Select Queries

We evaluated accuracy for selects over a single relation on a dataset from Census database described above (approximately 150K tuples). We performed two sets of experiments.

In the first set of experiments, we compared our approach to an existing selectivity estimation technique—multidimensional histograms. Multidimensional histograms are typically used to estimate the joint over some small subset of attributes that participate in the query. To allow a fair comparison, we applied our approach (and others) in the same setting. We selected subsets of two, three, and four attributes of the Census dataset, and estimated the query size for the set of all equality select queries over these attributes.

We compared the performance of four algorithms. AVI is a simple estimation technique that assumes attribute value independence: for each attribute a one dimensional histogram is maintained. In this domain, the domain size of each attribute is small, so it is feasible to maintain a bucket for each value. This technique is representative of techniques used in existing cost-based query optimizers such as System-R. MHIST builds a multidimensional histogram over the attributes, using the V-Optimal(V,A) histogram construction of Poosala. This technique constructs buckets that minimize the variance in area (frequency×value) within each bucket. Poosala et al. found this method for building histograms to be one of the most successful in experiments over this domain. SAMPLE constructs a random sample of the table and estimates the result size of a query from the sample. PRM uses our method for query size estimation. Unless stated otherwise, PRM uses tree CPDs and the SSN scoring method.

We compare the different methods using the adjusted relative error of the query size estimate: If S is the actual size of our query and is our estimate, then the adjusted relative error is

(|S−Ŝ|)/max(1,S)

For each experiment, we computed the average adjusted error over all possible instantiations for the select values of the query; thus each experiment is typically the average over several thousand queries.

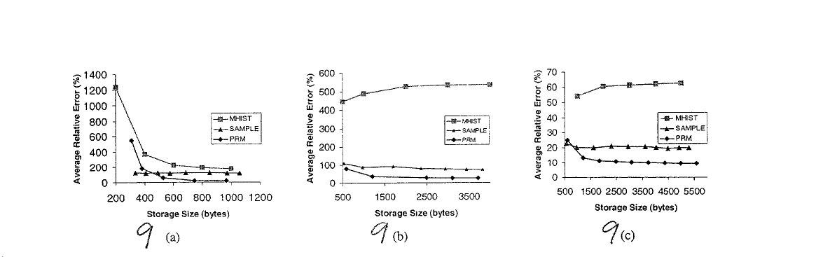

We evaluated the accuracy of these methods as we varied the space allocated to each method (with the exception of AVI, where the model size is fixed). FIGS. 9a-9c show results on Census for three query suites: over two, three, and four attributes. In all cases, PRM outperforms both MHIST and SAMPLE, and all methods significantly outperform AVI. Note that a BN with tree CPDs over two attributes is simply a slightly different representation of a multi-dimensional histogram. Thus, it is interesting that our approach still dominates MHIST, even in this case. As the power of the representations is essentially equivalent here, the success of PRMs in this setting is due to the different scoring function for evaluating different models, and the associated search algorithm.

In the second set of experiments, we consider a more challenging setting, where a single model is built for the entire table, and then used to evaluate any select query over that table. In this case, MHIST is no longer applicable, so we compared the accuracy of PRM to SAMPLE, and also compared to PRMs with table CPDs. We built a PRM (BN) for the entire set of attributes in the table, and then queried subsets of three and four attributes. Similarly, for SAMPLE, the samples included all 12 attributes.

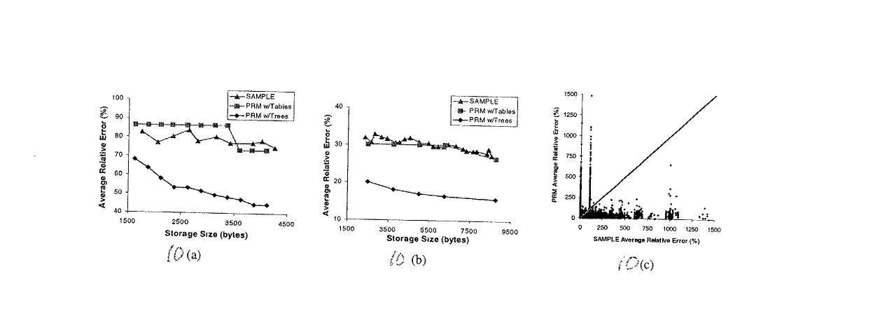

We tested these approaches on the Census dataset with 12 attributes. FIGS. 10a-10b show results for two different query suites.

Although for very small storage size, SAMPLE achieves lower errors, PRMs with tree CPDs dominates as the storage size increases. Note also that tree CPDs consistently outperform table CPDs. The reason is that table CPDs force us to split all bins in the CPD whenever a parent is added, wasting space on making distinctions that might not be necessary. FIG. 10c shows the performance on a third query suite in more detail. The scatter plot compares performance of SAMPLE and PRM for a fixed storage size (9.3K bytes). Here we see that PRM outperforms SAMPLE on the majority of the queries. (The spike in the plot at SAMPLE error 100\% corresponds to the large set of query results estimated to be of size 0 by SAMPLE.)

Select-Join Queries

We evaluate the accuracy of estimation for select-join queries on two real-world datasets. Our financial database (FIN) has three tables: Account (4.5K tuples), Transaction (106K tuples) and District (77 tuples); Transaction refers through a foreign key to Account and Account refers to District. The tuberculosis database (TB) also has three tables: Patient (2.5K tuples), Contact (1 9K tuples) and Strain (2K tuples); Contact refers through a foreign key to Patient and Patient refers to Strain. Both databases satisfy the referential integrity assumption.

We compared the following techniques. SAMPLE constructs a random sample of the join of all three tables along the foreign keys and estimates the result size of a query from the sample. BN+UJ is a restriction of the PRM that does not allow any parents for the join indicator variable and restricts the parents of other attributes to be in the same relation. This is equivalent to a model with a BN for each relation together with the uniform join assumption. PRM uses unrestricted PRMs. Both PRM and BN+UJ were constructed using tree-CPDs and SSN scoring.

We tested all three approaches on a set of queries that joined all three tables (although all three can also be used for a query over any subset of the tables). The queries select one or two attributes from each table. For each query suite, we averaged the error over all possible instantiations of the selected variables. Note that all three approaches were run so as to construct general models over all of the attributes of the tables, and not in a way that was specific to the query suite.

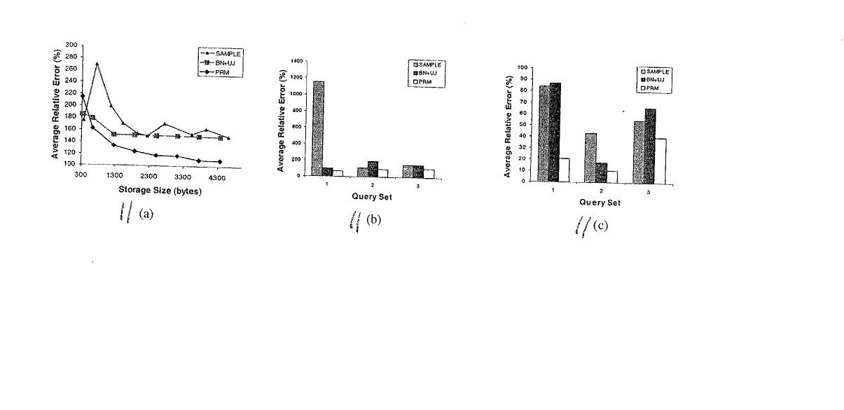

FIG. 11a compares the accuracy of the three methods for various storage sizes on a three attribute query in the TB domain. The graph shows both BN+UJ and PRM outperforming SAMPLE for most storage sizes. FIG. 11b compares the accuracy of the three methods for several different query suites on TB, allowing each method 4.4K bytes of storage. FIG. 11c compares the accuracy of the three methods for several different query suites on FIN, allowing 2K bytes of storage for each. These histograms show that PRM always outperforms BN+UJ and SAMPLE.

Running Time

Finally, we examine the running time for construction and estimation for our models. These experiments were performed on a Sparc60 workstation running Solaris2.6 with 256 MB of internal memory.

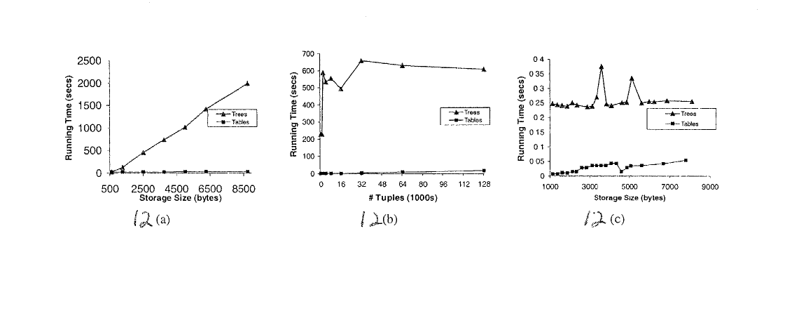

FIG. 12a shows the time required by the offline construction phase. As we can see, the construction time varies with the amount of storage allocated for the model: Our search algorithm starts with smallest possible model in its search space (all attributes independent of each other), so that more search is required to construct the more complex models that take advantage of the additional space. Note that table CPDs are orders of magnitude easier to construct than tree CPDs; however, as we discussed, they are also substantially less accurate.

The running time for construction also varies with the amount of data in the database. FIG. 12b shows construction time versus dataset size for tree CPDs and table CPDs for fixed model storage size (3.5K bytes). Note that, for table CPDs, running time grows linearly with the data size. For tree CPDs, running time has high variance and is almost independent of data size, since the running time is dominated by the search for the tree CPD structure once sufficient statistics are collected.

The online estimation phase is, of course, more time-critical than construction, since it is often used in the inner loop of query optimizers. The running time of our estimation technique varies roughly with the storage size of the model, since models that require a lot of space are usually highly interconnected networks which require somewhat longer inference time. The experiments in FIG. 12c shows experiments that illustrate the dependence. The estimation time for both methods is quite reasonable. The estimation time for tree CPDs is significantly higher, but this is using an algorithm that does not fully exploit the tree-structure; we expect that an algorithm that is optimized for tree CPDs would perform on a par with the table estimation times.

Conclusions

This embodiment of the third component of the invention comprises a novel approach for estimating query selectivity using probabilistic graphical models—Bayesian networks and their relational extension. Our approach uses probabilistic graphical models, which exploit conditional independence relations between the different attributes in the table to allow a compact representation of the joint distribution of the database attribute values. We have tested our algorithm on several real-world databases in a variety of domains—medical, financial, and social. The success of our approach on all of these datasets indicates that the type of structure exploited by our methods is very common, and that our approach is a viable option for many real-world databases.

Our approach has several important advantages. To our knowledge, it is unique in its ability to handle select and join operators in a single unified framework, thereby providing estimates for complex queries involving several select and join operations. Second, our approach circumvents the dimensionality problems associated with multi-dimensional histograms. Multi-dimensional histograms, as the dimension of the table grows, either grow exponentially or become less and less accurate. Our approach estimates the high-dimensional joint distribution using a set of lower-dimensional statistical models, each of which is quite accurate. As we saw, we can put these tables together to get a good approximation to the entire joint distribution. Thus, our model is not limited to answering queries over a small set of predetermined attributes that happen to appear in a histogram together. It can be used to answer queries over an arbitrary set of attributes in the database.

There are many interesting extensions to our approach, which allow it to handle much larger databases, e.g. providing an initial single pass over the data that can be used to home in on a much smaller set of candidate models, the sufficient statistics for which can then be computed very efficiently in batch mode. More interestingly, there are applications of our techniques to the task of approximate query estimation, both for OLAP queries and for general database queries (even queries involving joins).

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for estimating the selectivity of queries in a relational database, comprising the steps of:
constructing a probabilistic relational model (PRM) from said database; and
performing online selectivity estimation for a particular query.

2. The method of claim 1, wherein said PRM is constructed automatically, based solely on a data and space allocated to said PRM.

3. The method of claim 1, wherein said selectivity estimation step further comprises the step of:
said selectivity estimator receiving as inputs both said query and said PRM, and outputting an estimate for a result size of said query.

4. The method of claim 1, wherein the same PRM is used to estimate the size of a query over any subset of attributes in said database; and wherein prior information about a query workload is not required.

5. The method of claim 1, wherein selectivity estimation is performed for select queries over a single table; and wherein a Bayesian network is used to approximate joint distribution over an entire set of attributes in said table.

6. The method of claim 1, wherein selectivity estimation is performed for queries over multiple tables; and wherein one or more PRMs are used to accomplish both select and join selectivity estimation in a single framework.

7. The method of claim 1, further comprising the step of:
learning PRMs with link uncertainty with a heuristic search algorithm.

8. The method of claim 7, wherein said search algorithm comprises a greedy hill-climbing search, using random restarts to escape local maxima.

9. A method for learning probabalistic relational models (PRM) having attribute uncertainty, comprising the steps of:
providing a parameter estimation task by:
inputting a relational schema that specifies a set of classes, having attributes associated with said classes and having relationships between objects in different classes;
providing a fully specified instance of said schema in the form of a training database; and
performing a structure learning task to extract an entire PRM solely from said training database.

10. The method of claim 9, said structure learning task comprising the step of specifying which structures are candidate hypotheses.

11. The method of claim 10, said structure learning task comprising the step of evaluating different candidate hypotheses relative to input data.

12. The method of claim 11, said structure learning task comprising the step of searching hypothesis space for a structure having a high score.

13. A method for learning probabalistic relational models having link uncertainty, comprising the steps of:
providing a mechanism for modeling link uncertainty; and
said mechanism computing sufficient statistics that include existence attributes without adding all nonexistent entities into a database.

14. The method of claim 10, said mechanism comprising:
let μ be a particular instantiation of Pa(X.E);
to compute C_{X.E}[true,μ], use a standard database query to compute how many objects xεO^{σ}(X) have Pa(x.E);
to compute C_{X.E}[false,μ], compute the number of potential entities without explicitly considering each (x₁, . . . , xₖ)εO^{I}(Y₁)x···O^{I}(Yₖ) by decomposing the computation as follows:
let ρ be a reference slot of X with Range[ρ]=Y;
let Pa(X.E) be the subset of parents of X.E along slot ρ; and
let μ_{ρ} be a corresponding instantiation;
count a number of y consistent with μ_{ρ};
if Pa_{ρ}(X.E) is empty, this count is the |O^{I}(Y)|;
wherein the product of these counts is the number of potential entities;
to compute C_{X.E}[false,μ], subtract C_{XE}[true,μ] from said number.

15. A method for learning probabalistic relational models having link uncertainty, comprising the steps of:
providing a mechanism for modeling, link uncertainty; and
said mechanism computing sufficient statistics that include reference uncertainty, comprising the steps of:
fixing a set partition attributes ψ[ρ]; and
treating a variable S_{ρ} as any other attribute in a PRM;
wherein scoring success in predicting a value of said attribute given a value of its parents is performed using standard Bayesian methods.
